(19) United States
(12) Patent Application Publication
(10) Pub. No.: US 2012/0209907 A1
(43) Pub. Date: Aug. 16, 2012

(54) PROVIDING CONTEXTUAL CONTENT BASED ON ANOTHER USER

(76) Inventors: Anton O. A. Andrews, Seattle, WA (US); Ryan Powell, Seattle, WA (US); Andre O. M. Mohr, New York, NY (US); Jae P. Park, Bellevue, WA (US)

(21) Appl. No.: 13/027,066

(22) Filed: Feb. 14, 2011

(51) Int. Cl. G06F 15/16

(52) U.S. Cl. 709/204

(57) ABSTRACT

A content aggregation and distribution service, which can execute in a cloud computing environment, provides content based on a broadcast user's topics of interest to a subscriber user based on the context of the subscriber. An example of a broadcast user is a celebrity. Content is automatically gathered about the broadcast user's designated topics of interest from online resources, and filtered and distributed based on a context of the subscriber. Some examples of online resources are websites, social networking sites, and purchase transaction systems. An example of broadcast content is a recommendation which may have been entered directly to the service or posted by the celebrity in his or her social networking account. Both the broadcast user and the subscriber can control respectively the distribution and reception of content with subscription settings. For examples, the settings may set limitations with respect to topics, contexts, and subscriber profile data.

### BACKGROUND

With the widespread adoption of the Internet, more people have access to more information than ever before. For example, people can track topics of interest by navigating a variety of online resources like social networking sites, websites, online communities, web blogs, feeds in syndication formats such as RSS or ATOM, e-mails, and Internet search engines. Generally, the user manages accessing each online resource individually, and the user actively searches the content received from different online resources for information pertinent to the user's current circumstances. Although the user can reach out for information on their topics of interest, the user can still miss out on information about events, and experiences of others which he or she would have liked to have known about.

### SUMMARY

Technology is presented for providing content related to a user to another user based on a context of the other user. For ease of description, the user is hereafter referred to as a broadcaster or broadcast user, and the other user is hereafter referred to as a subscriber or subscriber user. An example of a broadcast user is a celebrity. Other examples include an organization, a brand, a work project, a band or other entity which has relevance in different contexts.

In one embodiment, the broadcaster and the subscriber each have accounts with a context relevant content aggregation and distribution service system which can be implemented in a cloud computing system or environment. Content is automatically and continuously gathered about topics of interest to the broadcast user. Some examples of topics of interests are people, places, things, activities, ideas, fields of study, research topics and one or more categories of or related to each topic. Some examples of content are a recommendation, an advertisement, a search result, a search term, a photo, a video, an audio clip, and comments entered in a social networking site or web blog, a text message, or an e-mail. Content can be derived or created based on content in different forms. For example, a message may be formulated based on data received from a purchase transaction application of a merchant system or a user device providing information about what a broadcaster bought in a location or type of store.

The context of the subscriber is determined on a continuous basis by the system based on context information received from one or more computer devices associated with the subscriber. Distribution of the content of the broadcaster is based on the context of the subscriber. In many embodiments, the distribution is based on the context of the subscriber and is performed independently of the current context of the broadcast user. Some examples of context information which may be used to determine a context for a user are actual physical location as may be provided by GPS, a WiFi connection point, or a cellular transmission point radius, IP address of a computer to which the user has logged in, a photograph to which an image recognition technique is applied, photo metadata, time of day and time of year, a computer network connection mode associated with a computer device, for example, work, home, public, etc., who is with the subscriber, an activity the subscriber is performing, an availability of the subscriber based on information stored by a scheduling software application, or what a subscriber is inputting to a user input device of an associated computer device communicatively coupled to the aggregation and distribution system.

The broadcaster and the subscriber can control distribution and reception of content based on subscription settings.

In one embodiment, the technology provides a method for providing content related to a user to another user based on a context of the other user. The method comprises subscribing a user account of a subscriber user to a user account of a broadcast user, and automatically gathering content about one or more topics of interest for the broadcast user from online resources. Context information is received from one or more client modules executing on one or more computer devices associated with the subscriber user. Content gathered for the broadcast user is filtered based upon contextual relevance to the subscriber user, and the filtered content is reported to one or more client modules executing on the one or more devices associated with the subscriber user.

In another embodiment, the technology provides a system for providing content related to a broadcast user to a subscriber user based on a context of the subscriber. The system comprises a first set of one or more computers comprising a radar service that is in communication with one or more client modules executing on computer devices associated with a broadcast user and a subscriber user, and a second set of one or more computers comprising an intelligence system that is in communication with the first set of one or more computers comprising the radar service.

The first set of one or more computers receives indications of topics of interest and context information from a first client module associated with the broadcast user and from a second client module associated with the second user. The second set of one or more computers stores one or more indexes of resources to search for information available for aggregation. The first set of one or more computers uses the indications of topics of interest from the first client module and the one or more indexes to automatically and continuously gather content about the topics of interest to the broadcast user from the information available for aggregation. Additionally, the first set of one or more computers filters the gathered content based on the topics of interest of the broadcast user and the context information provided by the second client module for the subscription user. The first set of one or more computers pushes the filtered content to one or more client modules executing on computer devices associated with the subscriber.

The technology also provides one or more processor readable storage devices having processor readable code embodied thereon, which when executed by one or more processors causes the one or more processors to perform a method for providing content related to a user to another user based on a context of the other user. The method comprises subscribing a user account of a subscriber user to a user account of a broadcast user. Content is automatically gathered about one or more topics of interest for the broadcast user from online resources, and a context is determined based on context information received from one or more client modules executing on one or more computer devices associated with the subscriber user. The content gathered for the broadcast user is filtered based on relevance to the context of the subscriber user, and the filtered content is reported to one or more client modules executing on one or more user computer devices in accordance with device limitations indicated by the subscriber user for receiving the filtered content.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram of one embodiment of a system from a hardware perspective in which one or more embodiments of the technology for providing content related to a user to another user based on the context of the other user can operate.

FIG. 2 is a block diagram of one embodiment of software components of a system for providing content related to a user to another user based on the context of the other user.

FIG. 3 is a flowchart of one embodiment of a method for providing content related to a user to another user based on the context of the other user.

FIG. 4 is a flowchart of one embodiment of a method for providing content related to a broadcast user to a subscriber user based on the subscriber context and subscription settings.

FIG. 5A is a flowchart of one embodiment of a method for obtaining settings from a broadcast user for subscribers to the broadcast user account.

FIG. 5B is a flowchart of one embodiment of a method for obtaining settings from a subscriber for receiving content for a broadcaster account.

FIG. 6A is a flowchart of one embodiment of a method for reporting content to a subscriber based on device limitation subscription settings.

FIG. 6B is a flowchart of another embodiment of a method for reporting content to a subscriber based on device limitation subscription settings.

FIG. 7A is a logical block diagram depicting one embodiment of a software architecture for a system in which one or more embodiments of the technology for providing content related to a user to another user based on the context of the other user can operate.

FIG. 7B is a logical block diagram depicting another embodiment of a software architecture for a system in which one or more embodiments of the technology for providing content related to a user to another user based on the context of the other user can operate.

FIGS. 8A-F depict various embodiments of a user interface on a client device.

FIG. 9 is a flow chart describing one embodiment of a process using magnets for automatically and continuously finding and aggregating content related to a broadcast user which is contextually relevant to a subscriber.

FIG. 10 is a flow chart describing one embodiment of a process for a client module obtaining data in an interactive manner.

FIG. 11 is a flow chart describing one embodiment of a process for a client module obtaining data in an active manner.

FIG. 12A is a flow chart describing one embodiment of a process for a client module obtaining context data in a passive manner.

FIG. 12B provides one example of an implementation of the process of FIG. 12A.

FIG. 13 is a flow chart describing one embodiment of a process for a client module reporting to a subscriber user.

FIG. 14 is a flow chart describing one embodiment of the operation of a magnet.

FIG. 15 is a flow chart describing one embodiment of a process for responding to events and identifying content for a subscriber user.

FIG. 16 is a block diagram describing the components of an example computing system that can be used to implement computer system components, for example those of FIG. 1, and embody the software and logical component examples and perform the processes described herein.

FIG. 17 is a top view of a portion of one embodiment of a head mounted display unit networked with a mobile device for use by the technology for providing content related to a user to another user based on the context of the other user.

FIG. 18 is a block diagram of one embodiment of the components of a head mounted display unit.

FIG. 19A is an illustration of an overlay of a radar like notification virtual overlay presented overlaying the subscriber's view of the subscriber's environment.

FIG. 19B is an illustration of a virtual overlay of contextually relevant content from exemplar broadcast user accounts to which the user subscribes presented overlaying the user's view of the user's environment.

FIG. 20 is a block diagram of one embodiment of the components of a head mounted display unit.

FIG. 21 is a block diagram of one embodiment of the components of a processing unit associated with a head mounted display unit.

FIG. 22 is a block diagram of an example mobile device which may be used to implement one or more embodiments of a client device.

### DETAILED DESCRIPTION

Technology described herein provides content based on a broadcast user's interests (e.g. celebrity's interests) to a subscriber based on the context of the subscriber. As mentioned above, a broadcast user to whose account others subscribe may be other than a human being. For example, the broadcast user account may be for an organization, a celebrity, a brand, a work project, a band or other entity which has relevance in different contexts. For example, human beings change their contexts constantly by traveling, performing different activities and associating with different groups of people. Organizations may have offices, programs and transactions in many different contexts. A work project may be supported by workers, online resources and materials having different contexts and contexts which change.

Relevance of content to topics of interest to a broadcast user may be determined from information typically stored in a user profile such as the user's demographics data, for example age, gender, and place of residence and identified topics of interests. Topics of interests may be identified by a user explicitly, and the content aggregation and distribution service system may identify topics passively, for example by monitoring a user's browsing history and social networking history.

Content is information which is in a form accessible by a computer system. For example, as permitted by a user the recording and streaming of a conversation by a smartphone results in streamed audio data which can be processed by a computer. Other examples include video, photographic and audio data stored in computer readable formats as well as text data and computer readable data representing physical sensations (e.g. vibrating smartphone) and movements. Content can also be generated which is derived from other content items.

The technology provides embodiments of a context relevant, content aggregation and distribution service which constantly gathers content relevant to a broadcast user from a variety of online resources, filters the content relevant to a context of a subscriber and reports the filtered content to the subscriber. The service presents content about a broadcast user to a subscriber based on the subscriber's context so the subscriber can act upon the information in the content.

The service may be embodied to leverage the power of cloud computing systems. A cloud computer system or environment of systems is able to communicate over communication networks using different protocols. For example, a cloud computing system may be implemented by computers which can interface with different types of communication systems and make the information available in formats for the other computers to access. Some examples of different types of communication systems are various wireless telecommunication systems to receive and forward telephone calls and Short Message Service (SMS) messages, Plain Old Telephone Service (POTS) and ISDN lines as well as computer networking standards such as TCP/IP, Ethernet and the wireless 802.11 series connection protocols.

The service provides advantages over other data discovery systems in that content is gathered from many different types of online resources such as e-mail, social networking sites, websites, and other data accessible via online communication networks as permitted by a user. Additionally, the content can be provided across many of a user's different types of computing devices.

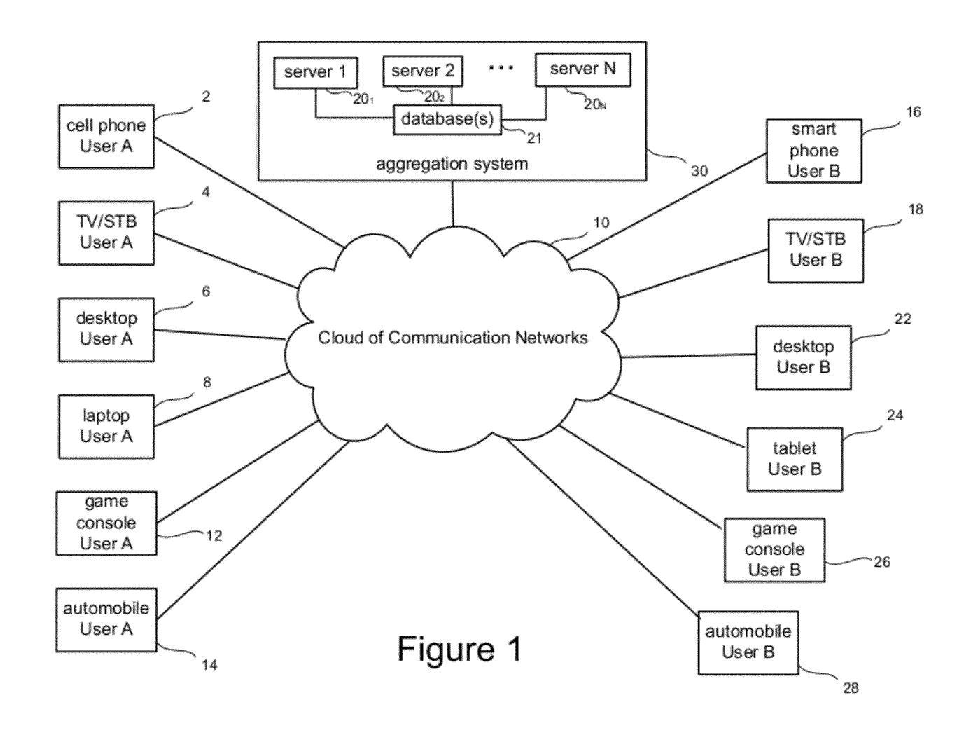

FIG. 1 is a block diagram of one embodiment of a system from a hardware perspective in which one or more embodiments of the technology for providing content related to a user to another user based on the context of the other user can operate. The block diagram of FIG. 1 shows a cloud of communication networks 10 which can include the Internet, another global network, and other types of networks or communication means. Exemplar sets of computing devices associated with exemplar users A and B are in communication with a context relevant content aggregation and distribution system 30 via cloud 10. The system 30 is likely to be in communication with devices for many users (e.g. many thousands or millions of users).

The exemplar computing devices for exemplar user A include a cellular telephone 2, a television or set top box 4, a desktop computing device 6, a mobile computing device such as a laptop 8, a game console 12 and an automobile based computer device 14. Some examples of computing devices for an exemplar user B are also illustrated including a smartphone 16, a TV/STB 18, a desktop computer 22, a tablet computer 24 as well as a game console 26 and an automobile based computing device 28. Computing devices 2-28 are examples of multiple computing devices that can be operated by a particular user. Other computing devices can also be used with the technology described herein. The user can interact with various entities via cloud 10 using any of the devices 2-28.

The context relevant content aggregation and distribution service system 30, automatically and continuously finds and aggregates relevant and current information about respective topics of interest based on the current respective contexts of user A and user B. The information is reported to the respective user, typically ubiquitously on a user interface of one or more of the respective user's devices 2-28. In one embodiment, system 30 includes one or more servers 20₁, 20₂ . . . 20_{N}. The number of servers used to implement system 30 is not a requirement, and is based on bandwidth, demand, performance of the servers and other factors that are implementation specific. In one example, system 30 is implemented by multiple server farms.

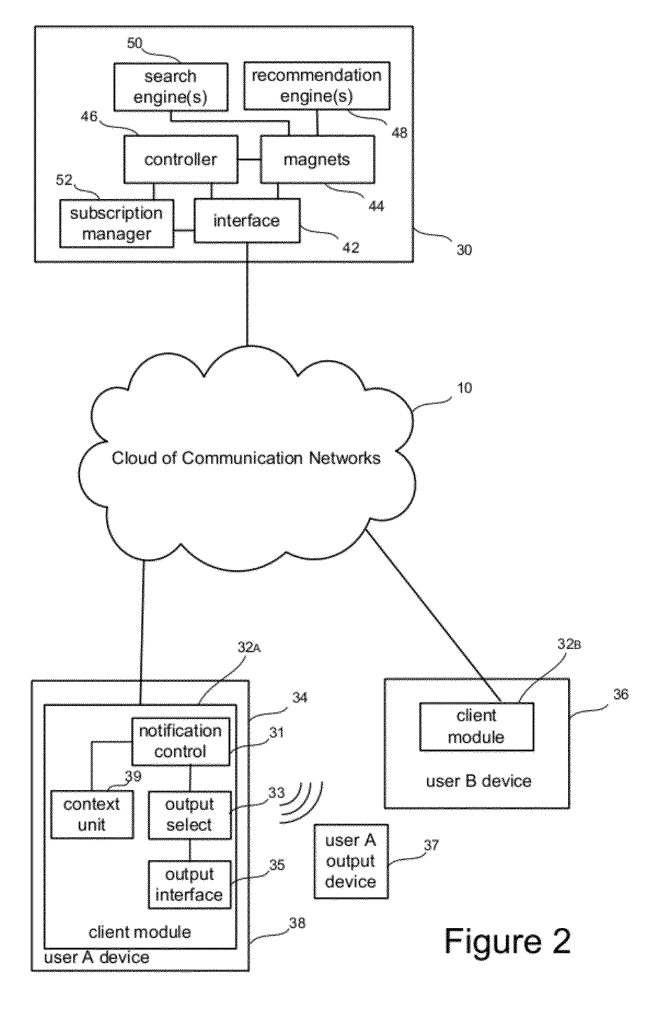

In operation, a user will use any of devices e.g. 2-14, 16-28 (at different times or concurrently) in order to perform various tasks (e.g., work, entertainment, social, etc.). These devices have software (e.g. a client module for the service as discussed in FIG. 2) embodied or stored on processor readable storage media like a memory, which may be in any of a variety of forms, and which executes on a processor in one or more of these devices. While operating these devices, a user indicates topics of interest via her actions which are tracked and communicated to the cloud based service system 30 by the client module executing software on the one or more devices. Some examples of such actions are types of sites visited and how often and when within a time period during Internet browsing (a user's visits to various baseball sites beyond a threshold can trigger the service to add baseball as a topic of interest), checking e-mails, telephone calls, text messages, videos and photos downloaded, data stored, search terms, and search results reviewed, search results not reviewed, posts to social networking sites, and explicitly entering topics to a topics list or subscribing to another user's account.

Additionally, by gathering information from sources such as IP addresses, computer network connection mode designations (e.g. work, home, public), Global Positioning System (GPS) modules, WiFi connection nodes, which computers a user is logged into, time of day, calendars, schedules, a subscriber identification module (SIM) for a mobile phone, applications being executed on a user computer device (e.g. a document processing application or a game) and the like, the client module software executing on the device can determine contextual information for the user and communicate this contextual information to the service in the cloud. The cloud based service system 30 may determine a context for the user based on contextual information derived from information from a variety of devices and online resources.

The topics of information and context information are received for further searching, aggregation and/or filtering of data in order to identify that data to a respective user (e.g. User A or User B) via any of the devices 2-28. The information sent to system 30 is also used to create a digital history for the user. In addition, it is used to make the system smarter, so the system can learn more about the user and improve the relevancy of the information that is pushed. Users A and B may each be subscribers of each other and broadcasters to each other.

FIG. 2 is a block diagram of one embodiment of software components of a system in which a system for providing content related to a user to another user based on the context of the other user can operate. FIG. 2 shows an embodiment of a set of software components which interact when executing to provide the cloud based aggregation and distribution service which automatically and continuously discovers, aggregates and filters content relevant to a user and his or her context. Furthermore, the software components interact to filter content relevant to a first user (broadcaster) based on the context of a second user (subscriber). The context based aggregation and distribution system 30 is in communication via a cloud 10 of communication networks with an exemplar user computer device 38 for User A and an exemplar user computer device 36 for User B, each with an executing instance of a software application, client module 32, which interacts with the components of the service 30. Some examples of user computer devices 2-28 were illustrated in FIG. 1.

User computer device 38 illustrates some examples of software components which may be embodied in a client module 32A. A notification control software unit 31 interacts with a communication interface 42, for example an application programming interface (API), of the service 30 for sending context information collected by a context unit 39 to the service 30 and receiving a notification of available contextually relevant content.

As illustrated in FIG. 2, a user computer device 38 may have access to different types of content output devices like user A output device 37. The output device 37 may be an audiovisual output device, another computer system with an output device like a MP3 player or larger display screen coupled, a stereo system (e.g. car, home) with a processor, software and a communication interface for communicating with other computer devices, a television or other communicatively coupled display system. An example of a communicatively coupled display system is a display on a wristwatch or other wearable item like jewelry. Another example is a display system like a head mounted display (HMD) or other see-through, mixed reality display which displays virtual content while allowing a user to view real world objects as well. An output device 37 outputs the notification or content in a format for a user's sensory perception (e.g. vibration pattern of a smartphone, visually displayed content on a screen or audio output by a speaker). A communicatively coupled output device may be registered by the user during set-up of his or her user account or identified by the client module 38. For example, when an operating system of the device updates device connections, the client module 32 may receive the update or periodically check and send a notification to the service 30 that an output device is currently coupled. In the example, the service 30 is not in direct communication with the selected output device but is able to communicate indirectly with the selected device (e.g. mixed reality wearable device) via a different device communicatively coupled to the selected device.

An output select software unit 33 identifies which output device is to provide the output to the user. This selection may be identified from the notification of content, for example in a message or metadata of the notification. As in the illustrated example of the communicatively coupled output device 37, via a wireless connection (e.g. Bluetooth) in this example, the output select unit 33 directs the notification or content to the output device 37 which has been selected for the content to be received. The selection of device may be based on the topic of the content and/or the context of the user. An output interface unit 35 formats the notification or content in a format which may be processed by the selected output device. A display or other audiovisual output device which is integrated in user computer device 38 may have been the selected output device in other examples.

In this embodiment, exemplar software components of the service 30 which provide content and determine the context for provision to the client modules 32 comprise magnets 44, a controller 46, one or more recommendation engine(s) 48, and one or more search engine(s) 50. Additionally, the software components comprise a communication interface 42 for communicating with computers of online resources via a variety of different communication protocols and with one or more client modules 32 executing on one or more user computer devices 36, 38. The software components of the service 30 further comprise a subscription manager 52 which filters content of a broadcast user based on relevance to the context of a subscriber second user subscribed to the broadcast user account. The manager 52 causes the filtered content to be reported to a client module 32 of a user device associated with the subscriber user. In some examples, the subscription manager 52 may also base the filtering on common topics of interest between the first and second users in addition to the context of the second user. The common topics may be identified passively by monitoring the online history of actions of each user or via active selection by each user.

The magnets 44 are software processes that automatically and continuously collect content about a topic of interest (e.g., person, place or thing). For example, magnets look for content (via cloud 10) relative to a seed (e.g., topic or specific content). For example, if a magnet is provided with a seed topic (e.g. a type of shoes, musical group, a subject matter, etc.) then the magnet will search the Internet (or other source) to find content available that is related to that seed. What makes the magnet different from a typical Internet search engine is that magnets are persistent, personalized based on information the magnet retrieves about a user as may be stored in a user profile, and other user information stored by other services and databases to which the system 42 has access via the interface 42. For example, another service may be a social networking site or an online gaming service such as XBOX® Live which stores a user's gaming statistics and preferences. A magnet may also use context in its searches and can interact with other magnets, can show many types of content (games, music, tweets, search terms) from both public and private indexes, and the content that is returned has context (such as returning a place and saying who else is there).

One or more magnets may be defined to search for content of a broadcast account which is relevant to the context of a subscriber user. Additionally, one or more magnets may be defined to search for an intersection of topics of interest for both broadcaster and subscriber and which are context relevant to the subscriber.

User interface representations for magnets allow a user to interact with them (e.g. to get information on a specific topic). For example, a user can interact with a magnet via a user interface (e.g., touch screen) to set up, configure and see results of a magnet. If a users pulls two magnet representations near each other (e.g., on a user interface), they'll effect each other. For example, a person pulls their restaurants magnet near their New York magnet on a touch screen display, and in response the two magnets interact and output an intersection of the topics being searched (e.g., restaurants in New York). The client module 32 reports the user input dragging the magnets to the service 30 which updates search parameters to limit restaurant results for restaurants in New York. Magnets may also be “pruned.” For example, a user may personalize a magnet about a singer to show fashion, music, and gossip, but never anything jail-related.

In one embodiment, magnets are virtual objects that attract similar particles, customized for a broadcast user and the subscriber user's context. A magnet is typically centered on a topic of interest and attracts a collection of particles related to that topic, filtered and prioritized based on the profile of the user who owns the magnet and the subscriber user's current context, for example the time, location, device, activity, and living things like pets and people the subscriber is with.

A particle is a statement or suggestion which may be displayed or outputted. A statement particle has a small amount of textual information such as “Stocks are down right now” or “Mom's birthday is tomorrow.” A suggestion particle may have a link to some digital content such as “Karma Club DJ Night” or “Halo® 2.” Suggestion particles like (i.e. find out the full Karma event details, or go play the game) can be acted upon. For example, a particle may include a Uniform Resource Locator (URL) or magnetic link which a user can select to find details for the event at the Karma Club or sign in online to the game of Halo 2. A user can magnetize a particle, give feedback on a particle, hide, or save a particle.

Particles can have value and actions. Examples of values include a pointer to the actual content, metadata (type, format, thumbnail), pizzazz (by surpassing a relevance threshold, a particle gets pizzazz, which draws attention to it), and relevance (the system 30 figures out the relevance and applies these values). Some examples of actions include “Go to the content,” “Magnetize this (have it attract similar particles, basically turning it into a temporary magnet),” “Give Feedback on this (thumbs up, thumbs down),” “Hide this (make this go away)” and “Pin this, so I can get back to it.” Other values and actions can also be included. Magnets attract particles related to a particular subject or interest. A digital history may include a trail of particles that a person acted upon or viewed at some point in the past. Aggregation system 30 shows the most relevant particles based on current context.

One or more search engines 50 are used to search various sources available via cloud 10. In one embodiment, a magnet 44 uses one or more search engines 50 to search. In other embodiments, magnets 44 and search engines 50 will search independently for information. Recommendation engine 48 will provide recommendations of information for a user based on the results from magnets 44 and search engines 50.

Controller 46 acts as the central brain that coordinates the operation of interface 42, magnets 44, recommendation engines 48, search engines 50 and subscription manager 52. In operation, topics of interest and context information is received at interface 42 and provided to controller 46. In one embodiment, the controller 46 provides the topics/and or context information to magnets 44, recommendation engine 48, search engines 50 and subscription manager 52 in order to obtain additional data and/or to filter data already found. In some embodiments, magnets 44, recommendations engines 48, search engines 50 and subscription manager 52 provides all of the data to the controller 44 which filters the data based on the context information and provides the result of the filtering to the appropriate client module (36 or 38) via interface 42. In some situations, the information is reported to the subscriber user on the same device/client that provided context information to system 30. In other situations, the context information is provided to system 30 from a first device associated with the subscriber (e.g., device 2 for User A) and the information from system 30 is pushed to a second device associated with the subscriber user (e.g., device 4 for User A) because the subscriber has changed the device the subscriber is working with or the second device is a more appropriate platform to report the information.

The subscription manager 52 interacts with a user computer system via the interface 42 to set a user account to be subscribed to or to associate a user account as a subscriber to another user account. After the account subscription settings have been updated, in one example, an instance of the subscription manager 52 may execute for filtering the content of a broadcast user account based on one or more contexts of subscriber accounts. The controller 46 may send a message when content is available for different users or the subscription manager may perform periodic checks of one or more database(s) (e.g. 21) to identify new content for the broadcast account. The context of the subscriber users associated with the broadcast user account is monitored. Additionally, the subscription manager 52 may use one or more magnets to track mutual topics of interest for filtering the broadcast content which may be forwarded to a subscriber. Furthermore, the broadcaster, subscriber or both may have selected settings which are also criteria for filtering the broadcast content. The subscription manager 52 may notify the controller 46 of the filtered content to be sent, the interface 42 or both. In some examples, the controller 46 directs the user profile data of the broadcast user and subscribers be updated to reflect the content sent to the subscribers.

In other embodiments, some of the functions of the software components of the service 30 may be processed by the client modules 32 or both software instances of one or more components (e.g. 42, 46, 44, 50, 48 and 52) operating on servers (e.g. 20) and the client modules 32.

For illustrative purposes and ease of description only, reference is made to the software components of FIG. 2 in the discussions of the method embodiments in the figures below. The processes discussed are not limited to a particular system implementation; in other words they may operate within other system embodiments.

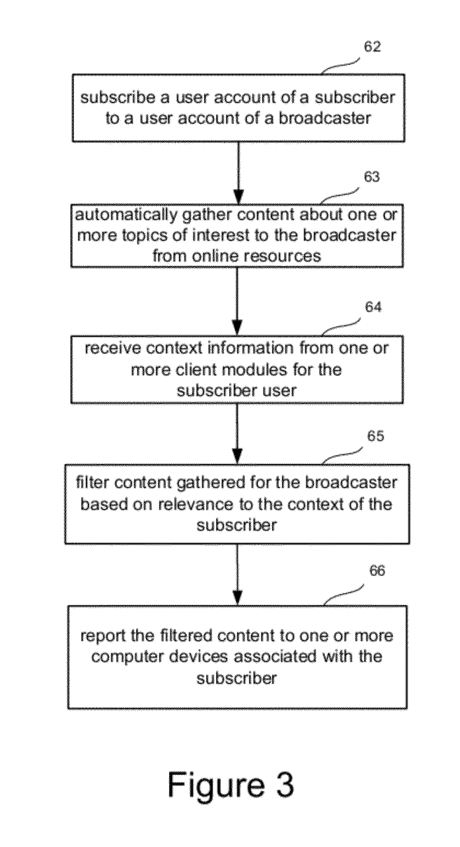

FIG. 3 is a flowchart of one embodiment of a method for providing content related to a user to another user based on the context of the other user. A user indicates via user input at one of the user's computer devices 38 that he or she wishes to permit other users of the cloud based content aggregation and distribution service 30 to subscribe to his or her account. The service 30 modifies the user account settings as a broadcast account. In step 62, the subscription manager 52 subscribes a user account of a subscriber to a user account of a broadcaster.

In step 63, the service 30 automatically gathers content about one or more topics of interest to the broadcaster from online resources and receives in step 64 context information from one or more client modules for the subscriber user. The subscription manager 52 in step 65 filters content gathered for the broadcaster based on relevance to the context of the subscriber and works with the service 30 components to report in step 66 the filtered content to one or more computer devices associated with the subscriber. In some embodiments, the filtering is based on the current context of the subscriber and is independent of the current context of the broadcast user.

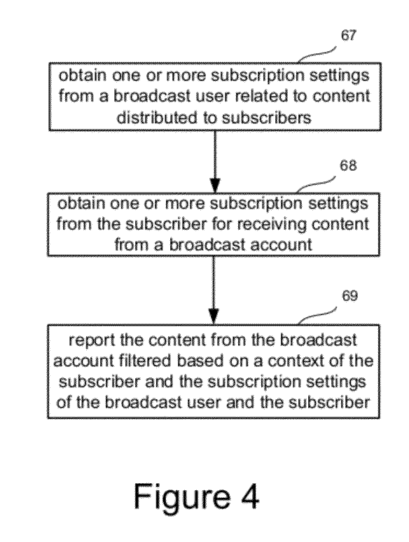

FIG. 4 is a flowchart of one embodiment of a method for providing content related to a broadcast user to a subscriber user based on the subscriber context and subscription settings. Both a user providing content to subscribers and a subscriber may desire to update subscription settings to place limitations relating to the content distribution and reception. Default settings may be used by the subscription manager 52 in the absence of user selections.

The subscription manager 52 may in step 67 obtain one or more subscription settings from the broadcast user related to content distributed to subscribers. The subscription manager 52 may also in step 68 obtain one or more subscription settings from a subscriber for receiving content from the broadcast user account. In some examples, the subscriber may have settings indicating to display the content without waiting for a user response to the notification. In step 69, the service 30 reports the content from the broadcast account filtered based on a context of the subscriber and the subscriptions settings of the broadcast user and the subscriber.

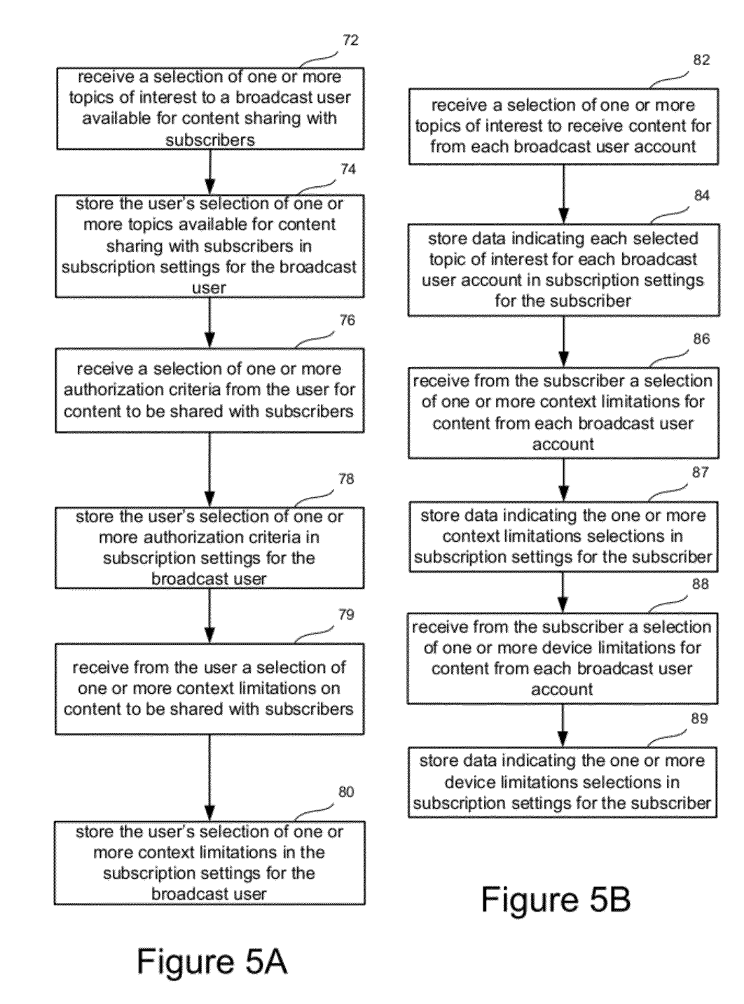

FIG. 5A is a flowchart of one embodiment of a method for obtaining examples of settings from a broadcast user for subscribers to an account of the broadcast user. For both the broadcaster and the subscriber (see FIG. 5B), the manager 52 may output via the interface 42 to a user computer device selections for settings which a client module 32 formats into a user interface, for example a displayed menu or voice activated menu, through which a user can provide user input regarding the settings. A user makes his or her selections on a user interface of the user computer device (e.g. any of 2-28) and these are transmitted back to the interface 42 which directs them to the subscription manager 52.

In step 72, the subscription manager 52 receives a selection of one or more topics of interest to a broadcast user available for content sharing with subscribers and stores in step 74 the broadcaster's selection of the one or more topics in subscription settings for the broadcaster. The selectable topics of interest may have been identified or recommended or both by the service 30 for the user for selection to be shared with subscribers. For example, a famous celebrity chef may only want to share content related to cooking and kitchen design, but not his personal life or financial deals. In this way, a broadcast user can indicate which topics he or she wants to be shared with subscribers of the service independent of the online source for the content. The chef may have a Facebook® page and a Twitter® page and can enter information, e.g. a recipe or restaurant review, on either one of these social networking sites and know it will be distributed to his subscribers who have an account with the service by the service 30 whether or not his subscribers have a Facebook or Twitter account.

In step 76, the subscription manager 52 receives a selection of one or more authorization criteria for content to be shared with subscribers. A broadcast user may set an authorization criteria that he or she approve every selection or item of content to be sent to subscribers. In another example, the broadcast user may designate only items initiated by the broadcast user as being permitted to be shared with subscribers. In the famous chef example, the chef may not want content of reviews of his recipes or TV program by critics sent to all subscribers, but permits a review or recipe he enters to be shared automatically. In another example, the chef may limit by authorization criteria the types of content to be shared. For example, he may not wish his search terms for a prime rib recipe shared with subscribers, but only items he designates as recommendations like his “likes” and “dislikes” lists from one of his social networking sites and comments he initiates. Subscribers may be grouped into categories and different authorization criteria applied to the different categories. For example, demographic data from user profiles and other identifying characteristics (e.g. approximate weight class, or relationship to the user) may be used to group subscribers. The subscriber manager 52 in step 78 stores the selected authorization criteria in a subscription settings datastore (e.g. in a database 21 controlled by the service) for the broadcast user account. The broadcast user account settings may be stored or linked as part of user profile data for the broadcast user as well.

Additionally, the subscriber manager 52 in step 79 receives from the broadcast user a selection of one or more context limitations on content to be shared with subscribers. A celebrity or members of an organization may not want children receiving content during school hours or when a subscriber is driving or at work. For example, through GPS and device settings, the user computer device of a subscriber can provide this context information so the controller 46 and/or the magnets 44 and the subscription manager 52 determine a subscriber's context includes respectively “school” “driving” or “work.” In another example, the broadcast user can designate a time delay on content distributions. For example, a context limitation may be set for privacy considerations such that context information on the location of the broadcaster or an activity he or she performed at a location is not published to subscribers until a set time period (e.g. a day, a week, two hours) after the broadcast user has left the location. In step 90, the subscription manager 52 stores the broadcast user's selection of one or more context limitation selections in the subscription settings for the user. The subscription settings for each broadcast user account associated with a user may also be stored or linked as part of the user's profile data.

FIG. 5B is a flowchart of one embodiment of a method for obtaining examples of settings from a subscriber for receiving content for a subscription account. A user may have selected a subscription indicator on a user interface of a user computer device for subscriptions in general or responsive to a particle asking the user if he or she wanted to subscribe to a user account associated with a content item, e.g. a link with a displayable statement asking if she wants to subscribe to the account of the chef after the user has been identified as being at home when the TV program of the chef was playing on her TV. In step 82, the subscription manager 52 receives a selection of one or more topics of interest to receive content for from each broadcast user account and stores in step 84 data indicating each selected topic of interest for each broadcast user account in subscription settings for the subscriber.

Analogous to the user providing the content to the subscriber, the subscriber can indicate for which topics he or she wants to receive content from the broadcast account independent of the online source for the content. In the chef example above, the chef may enter a comment on his Facebook or Twitter page, and the subscriber need not have accounts with either of these social networking entities and still receive the comment in his or her service account. If the chef says one thing on Facebook and another on Twitter, a subscriber with accounts to these does not need to log in to see the comments; both are pushed to the subscriber via the service 30.

The subscription manager 52 also presents the subscriber the opportunity to limit the context in which he or she receives broadcast content. For each account to be broadcast, in step 86, the subscription manager receives from the subscriber a selection of one or more context limitations for content from each broadcast user account and stores in step 87 data indicating the one or more context limitations selections in the subscription settings for the subscriber.

An example of a context limitation is a limitation to not receive content when the subscriber is physically at work, or connected to his or her work computer network (e.g. work mode) or driving or while the subscriber is at the gym or meditation class. Additionally, context limitations may limit content by topic. Another set of limitations, which may be considered a subset of context limitations, are device limitations. For example, work project account or a subscriber to that project account may set the subscription settings so that subscribers, those working on the project, may only access content for the work project on any subscriber device logged in via a secure connection to a designated work computer network. However, a subscriber may set subscription settings that content about a celebrity's social life is limited to one or more particular user computer devices and may also be limited to which network (e.g. home, school or work) a device is connected.

For each broadcast account to be subscribed, in step 88, the subscription manager receives from the subscriber a selection of one or more device limitations for content from each broadcast user account and stores in step 89 data indicating the one or more device limitations selections in the subscription settings for the subscriber.

Subscription settings for both the broadcast user and the subscriber may be linked to the respective user profile data.

Below is an example of how content may be generated, captured and distributed by a subscription service for providing content related to a user to another user based on the context of the other user. Returning to the celebrity chef for this example, the celebrity sets up his user account with the context relevant content aggregation and distributions service (e.g. 30). As part of this, the celebrity chef may enter demographic data about himself, select topics of interest, link external accounts (e.g. Facebook, Twitter, Mint.com) provide access privileges to the service 30 as desired, and set his subscription settings for subscribers to his account, and for himself for any accounts to which he subscribes.

The celebrity chef has lunch at a new restaurant in Vancouver. He may be located there by the GPS in his mobile telephone or by information he uploads to his service account or an external account linked to his service account. For example, the chef launches his client module 32 and enters a ‘likes’ recommendation for the restaurant and adds a comment “try the pretzel with welsh rarebit!” The cloud service may create a ‘place card’ display for the restaurant with information like its name, address, hours, phone, and the celebrity's comments. The subscription manager 52 monitors content received for the celebrity, for example by being registered with an API to receive notice of updates to the celebrity's account or is continuously checking the account records for new content. The subscription manager 52 identifies the recommendation and place card storage location in a database 20. The subscription manager 52 looks at contexts currently identified with subscribers to the celebrity chef's account.

A user who subscribes to the celebrity chef account launches his client module 32 on his smartphone (e.g. 16). The user may actively indicate he is ready to receive updates from the celebrity chef's account. The smartphone 16 provides context information (e.g. SIM card location or GPS status) to the service 30 which the subscription manager 52 accesses. The user walks within a present distance of the Vancouver restaurant for which the celebrity chef provided a recommendation. The subscription manager 52 may also use the subscriber's preferences in his user profile data for determining if content is to be made available to the user. For example, the subscription manager 52 may determine not to share a celebrity chef's comments on a crab house restaurant when the subscriber's profile indicates he is allergic to shell fish or does not want information on such types of restaurants.

Assuming the type of restaurant is not a limitation on sharing content, the subscription manager 16 sends a notification to the notification controller 31 of the smartphone which displays via the output interface 35 a notification for indicating to the user that he is in proximity to the restaurant that the celebrity recently visited. The user taps on the notification on his smartphone user interface and is able to view the restaurant's place card including the celebrity's comment about the pretzel which has also been downloaded from the cloud based service. The user may then decide to walk up to the restaurant to check out the interior and a menu.

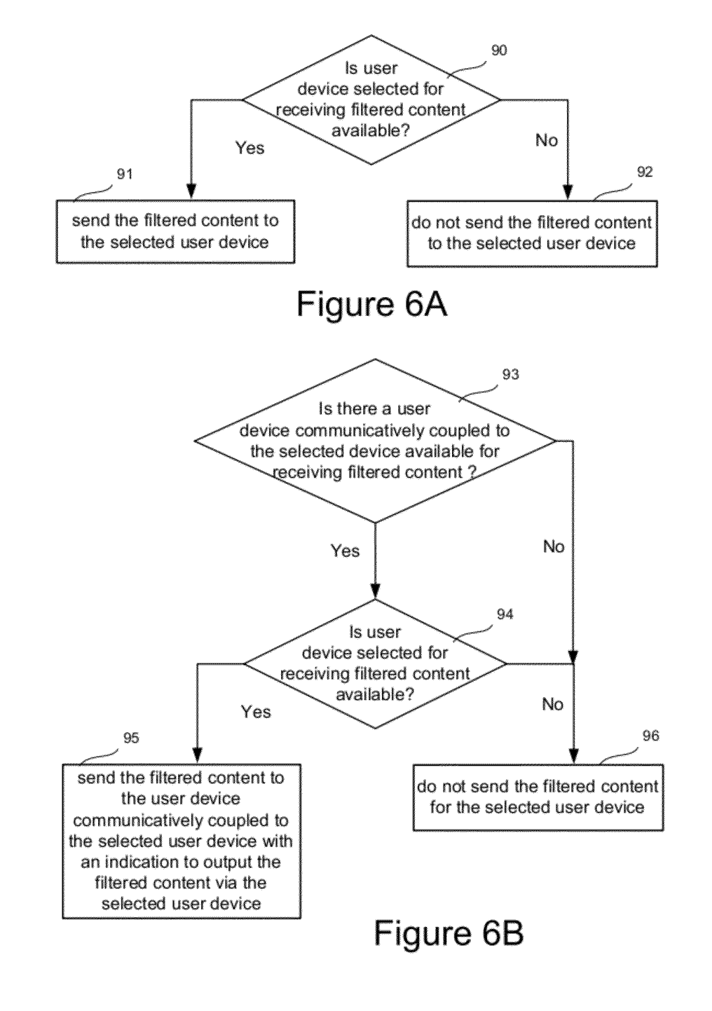

FIG. 6A is a flowchart of one embodiment of a method for reporting content to a subscriber based on device limitation subscription settings. The service 30 determines in step 90 whether a user device selected by the subscriber for receiving filtered content from a broadcast user account is available. In one example, the subscription manager 52 may check the latest context information for that device to determine whether it is available for receiving the content. The device may be considered available if it is in a vicinity of the user, such as a preset distance or a location such as the user's home or office building. User activity on a device may be an indicator that the device is in the vicinity of a user, especially if the user has provided login credentials for the session. The device may be determined to be unavailable based on a network connection mode type, for example a work mode. Additionally, if the user device is off as may be indicated by a SIM card or not responding to a status message, the device may be considered unavailable. If the device is available, the subscription manager 52 sends or causes to be sent the filtered content to the selected user device in step 91. If the device is determined to be unavailable, the filtered content is not sent in step 92 to the selected device. In other examples of the process, the filtered content may be sent within a time period if the selected device becomes available and the other context limitations are met, may be sent to an archive for the subscriber to retrieve later, or may be sent to an alternate device for output per the device limitations.

FIG. 6B is a flowchart of another embodiment of a method for reporting content to a subscriber based on device limitation subscription settings. In this embodiment, the selected device is an output device which is not directly accessible for communication by the service 30 which must obtain information about the device's status from another computer device. The subscription manager 52 in step 93 determines whether there is a user device communicatively coupled to the selected device available for receiving the filtered content. If not, the subscription manager 52 does not sent the filtered content for the selected device in step 96 and may pursue one of the options described following the discussion of step 92.

If such an intervening communication device is available, the subscription manager 52 determines whether the selected user device is available for receiving content in step 94. For example, the subscription manager 52 may check context information from the intervening device which besides things it may contain like a network connection mode, IP address and physical location (e.g. based on GPS, cell tower connection, WiFi Hotspot connection) may also include other devices connected or communicatively coupled to it wired or wirelessly. Additionally, the subscription manager 52 may send messages to the client module on the intervening device to obtain the connection status of the selected device. Again, if the selected device is determined not to be available, for example, it is not connected to the intervening device, then in step 96, the subscription manager does not send the filtered content for the selected device. If, however, the selected device is available, the subscription manager 52 in step 95 sends or has sent the filtered content to the intervening user device communicatively coupled to the selected user device with an indication to output the filtered content via the selected user device.

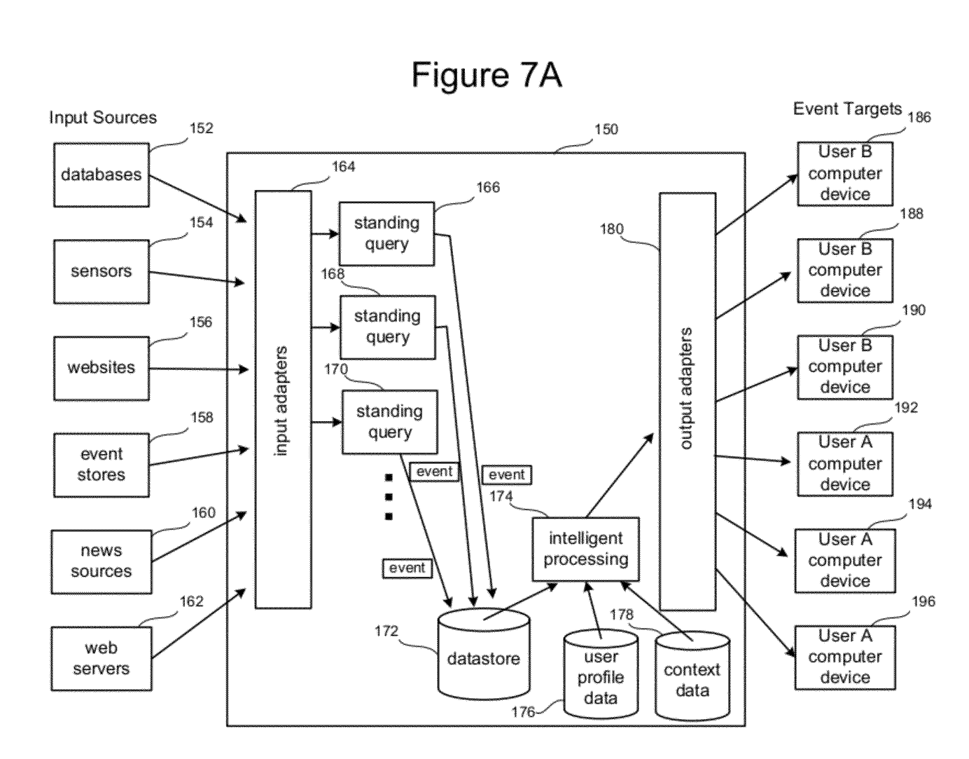

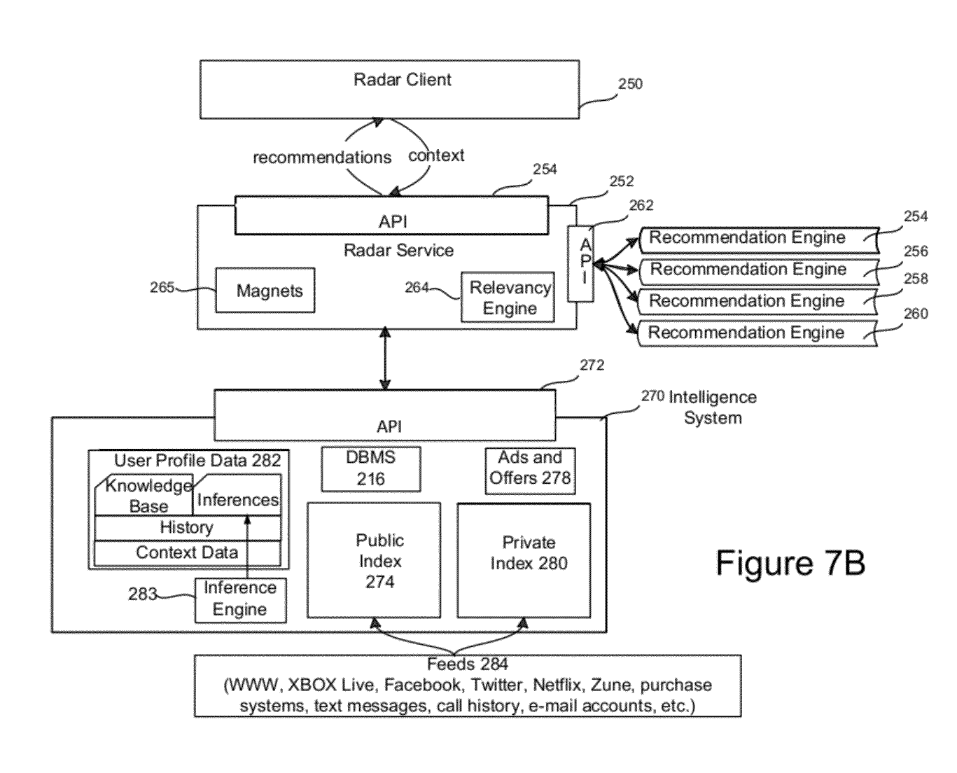

FIG. 7A is a logical block diagram depicting one embodiment of a software architecture for a system in which one or more embodiments of the technology for providing content related to a user to another user based on the context of the other user can operate. The depicted software components automatically and continuously discover, aggregate and filter relevant and current information for users. System 150 is another embodiment of an aggregation system 30 which can be implemented by one or more computers. Data is acquired by system 150 from many different input sources, such as databases 152, sensors 154, (e.g., cameras, temperature sensors, GPS sensors, other positional sensors, etc.), web sites 156, event stores 158, news sources 160 and web servers 162. Other sources can also be used (e.g., social networking systems, communication systems, data warehousing systems, etc.). Data from these sources are provided to one or more input adaptors 164 which obtain the data, scrub the data, reformat the data and provide it to one or more appropriate standing queries 166, 168, 170, . . . In one embodiment, standing queries 166, 168, 170, . . . correspond to magnets 44. When a standing query identifies information relevant to the query, a database record will be generated with information about what was found from the input source. This generated database record is an event for the system of FIG. 7A, and the database record is stored in a database 172.

In response to an event, an intelligent processing module 174 will obtain appropriate data in data store 172, user profile data 176 and context data 178. The user profile data can be information about a user such as demographic information, behavioral information, web browsing history, search topics, friends, user accounts subscriptions, etc. Context data is gathered for identifying a current context or context in a defined time period for a subscriber user and can also be gathered for a broadcast user to be stored as data upon which context relevance for a subscriber is determined Examples of context data include the location of a user, what a user is doing, what device the user is interacting with, who the user is interacting with, what the user is saying, time of day for the user, current persona of the user (e.g., parent, employee, spouse, coach, commuter, etc.). The intelligent processing module 174 evaluates the information described above and identifies information of interest to a subscriber based on that evaluation. Additionally, intelligent processing 174 may utilize one or more recommendation engines and/or search engines. In one example, the process embodiments of FIGS. 3-6B may be performed by the intelligent processing module 174.

In one embodiment, there's a secondary form of intelligent processing that takes the user profile data, the history, behaviors, (and possibly everything known about a user from using properties like email, messenger, Internet searches) for the broadcaster and the subscriber, and combines that data together to make intelligent inferences. For example, the inference engine may determine that both are financial gurus, but the subscriber is not that interested in sports. Even if the broadcaster has selected sports as a sharable topic, the intelligent processing engine may implement a rule to only share sports information if the subscriber is at a sporting event or viewing one on TV or the Internet. For financial information, the system may follow a rule to forward financial information content from the broadcaster in many more contexts allowed by the subscriber and deemed relevant by the service. Some inferences receive higher confidence values based on user actions. For example, finance as a topic of interest may receive a high confidence value and a magnet is created for finance. Each of these inferences about the broadcaster and subscriber is assigned a confidence level value for how much mutual interest there is in the topic.

The intelligent processing module 174 sends information identified as contextually relevant content for a subscriber to an output adaptor 180 which adapts the data for the particular target user computing device. Some examples of the target devices shown in FIG. 7A like 186, 188, 190 associated with exemplar User B and those 192, 194, 196 associated with exemplar User A may be those shown in FIG. 1 like a cell phone 2, television (or set top box) 4, 18, desktop computing device 6, 22, mobile computing device (laptop 8, tablet 24, smartphone 16), game console 12, 26 and automobile computer interface device 14, 28. Other target user devices can also be utilized. Output adapters 180 will package the data for the appropriate target and communicate using the appropriate protocol. In one embodiment, input adapters 164 and output adapters 180 may be used to implement interface 42 of FIG. 2.

Any one or more of the components of FIG. 7A can be created in an object oriented manner so that the system can process many different users concurrently. In such an embodiment, the system will create an instance of itself for each of multiple users. In one example, a single instance is associated with one or more mosaic identity facets and other contextual data that is used as the central point or the foci in the stream processing. As an example, one instance can be centered on a Facebook identity, another on a corporate identity, and a third on a combination of them. An instance can also be configured with a group of different facets as its focus.

FIG. 7B is a logical block diagram depicting another embodiment of a software architecture for a system in which one or more embodiments of the technology for providing content related to a user to another user based on the context of the other user can operate. The software components also automatically and continuously discover, aggregate and filter content contextually relevant for a subscriber to another user's account.

In this embodiment, an example of a client module 32 identified as a radar client 250 is software running on any of the physical computing devices of a user which is in communication via a software interface such as the exemplar application programming interface (API) 254 with one or more applications of a cloud based, contextually relevant content aggregation and distribution service, referred to here as a “radar” service 252. Like a radar, the service 252 and client modules 250 search for information and track it. A radar client 250 provides context information (and, optionally, information about a user's interest) to radar service 252 and receives back content such as recommendations from a broadcast user account.

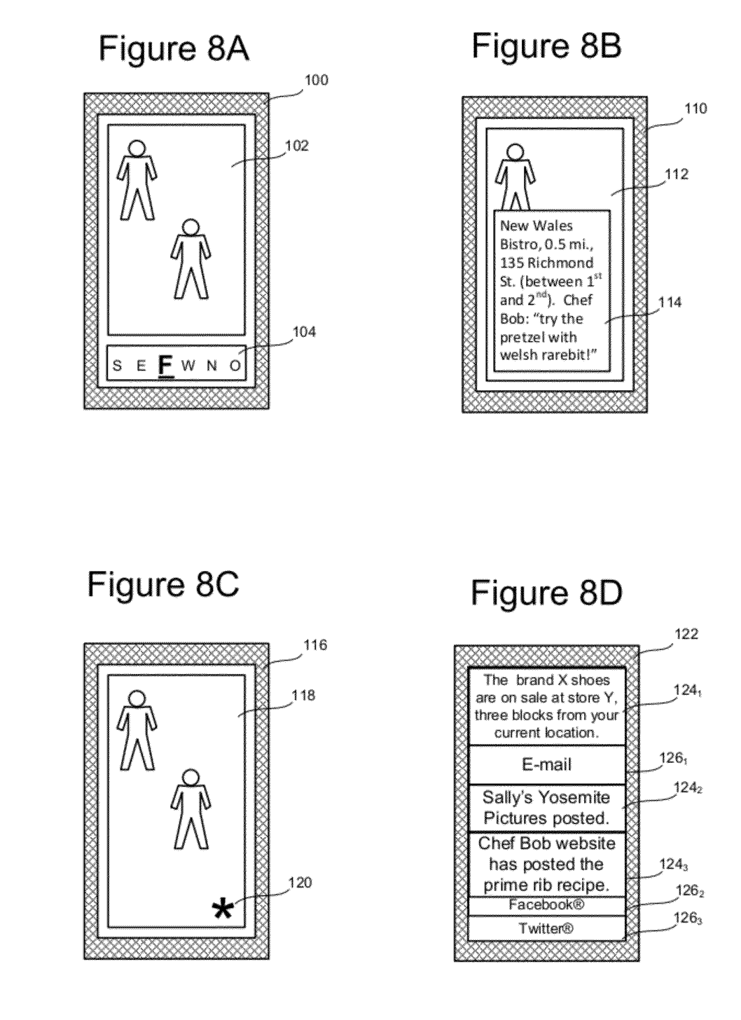

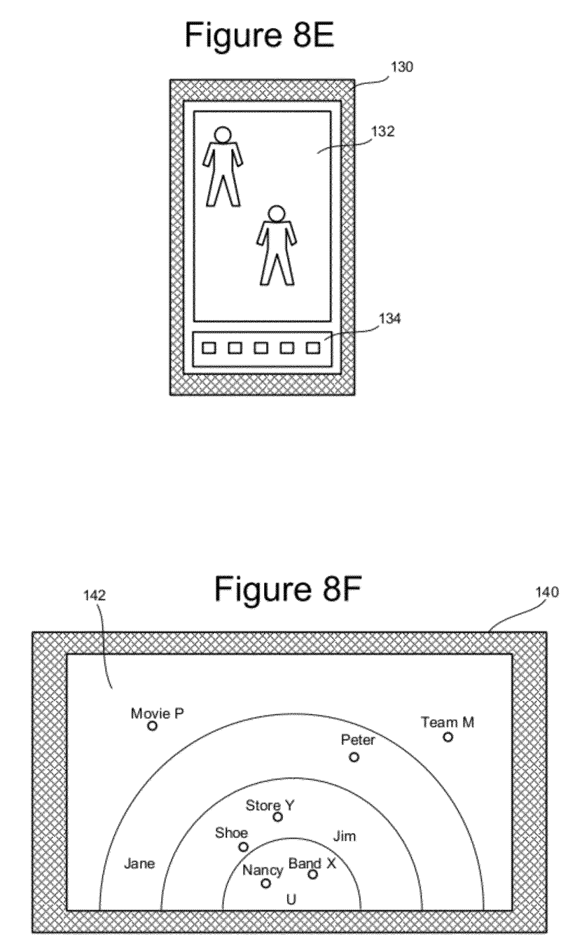

The received content, e.g. recommendations, can be reported to the subscriber as discussed below (see e.g. FIGS. 8A-8F).

The cloud based radar service 252 includes an API for a set of recommendation engines 254, 256, 258 and 260, each of which makes different types of recommendations for different types of content. For example, one recommendation engine may make recommendations for music, another for shopping, another for parties, another for restaurants, etc. A system can have more than four recommendation engines. The radar service 252 includes magnets 265, which are discussed above, and a relevancy engine 264. Magnets make use of the recommendation engines to identify content for a user. Additionally, recommendation engines can make recommendations without a magnet involved. Magnets use an API 272 to an intelligence system 270 to mine the world of knowledge for information related to one or more topics of interest to a broadcast user or of mutual interest to a broadcaster and a subscriber. Magnets use the recommendation engines to make interesting recommendations for the subscriber about the one or more topics based on the current context of the subscriber. All information and recommendations made by both magnets and recommendation engines are then sorted by the relevancy engine 264 and provided to the radar client 250.

In one embodiment, magnets make use of the recommendation engines to identify content for a user and the one or more instances of relevancy engines scores each item of content based on its perceived relevancy to the current context of a subscriber. In one embodiment, the relevancy engine 264 provides a numerical relevancy score based on how pertinent the item content is to the current context of the subscriber. For example, a restaurant recommendation may get a higher relevancy score between 3-5 PM, then at midnight. Similarly, information about a football team may receive a higher relevancy score during the football season than between seasons. Information about a band the subscriber is currently listening to, will get a higher score, than another band or other content related to work.

Additionally, in this embodiment, the relevancy engine 264 evaluates gathered content for relevance to the subscription settings of the broadcaster and the subscriber. The relevancy engine 264 identifies content for output processing to the subscriber by the other components in the system such as the radar service 252 and its API 254.

As noted above, the radar service 252 communicates with the intelligence system 270 via an API 272. The intelligence system 270 creates, obtains and stores information about data available to the radar service 252. In one embodiment, the radar service 252 is implemented by a set of one or more computers (e.g., a server farm) and the intelligence system 270 is implemented by a different set of one or more computers (e.g., a server farm). In other embodiments, one or more of the same computers can implement both the radar service 252 and the intelligence system 270.

In one example, database management software 216 may be contacted by the radar service via the API 272 to access data from the intelligence system 270 which includes a public index 274, a datastore or index for ads and offers 278, a private index 280 and user profile data 282. The public index 274 may be an Internet Search index of web sites on the World Wide Web. The private index 280 includes a separate index of private sites for each user. For example, each user will have a private index which provides information about their social networking pages, email, contacts, etc. In some embodiments, the user logins to the radar service via a single sign-on procedure allowing the radar service to maintain sessions with the user's private accounts. The ads and offers datastore 278 provides a list (e.g. with a pointer to or the actual content) of advertisements and offers to consumers that are available. User profile data 282 stores information known, e.g. knowledge base, and inferred, e.g. inferences, for each user as well as context data and history data including a digital history for the respective user.

In one embodiment, the intelligence system 270 includes an inference engine 283, which is software that guesses information about users based on their behavior. The inference engine can provide context information for a subscriber that includes an intent or state of being of a subscriber derived from an inference based on an action of the subscriber. For example, if a subscriber is reading about a restaurant, the inference engine may assume the user is desiring to eat (e.g., the user is hungry). The response may be to show the user comments from a celebrity broadcaster of a restaurant nearby that serves the food the user was observed to eat in the past. The public index 274, ads and offers store (or index) 278, and the private index 280 are created based on crawling or searching on the World Wide Web, social networking systems, collaborative services, multiplayer game services, search engines, movie and music distribution services, purchase systems, text messages, call history, e-mail accounts, examples of which are illustrated as feeds 284 and/or other networks or sources.

In operation, magnets 265 will utilize the recommendation engines 254, 256, 258, 260, the public index 274, the ads and offers store (or index) 278, the private index 280 and the user profile data 282 to identify content of interest to the user. The relevancy engine 264 provides a relevancy score for the items found based on the subscriber's current context. Items of content closest to the subscriber's current context will be given a higher score. Items with the higher scores will be pushed to the radar client module 250 on a subscriber device by the cloud based radar service 252.

The processes, software components or the functionality they provide may be embodied or stored as code, software, instructions, firmware, or the like on processor readable storage media and which can be executed by a processor. An example of processor readable storage media are a computer readable storage medium such as memory, whether in a volatile or non-volatile form, removable or non-removable. Furthermore, the particular naming and division of the modules, applications, software components, and other aspects are not mandatory, and are used for illustrative purposes. The mechanisms that implement the technology or its features may have different names, divisions and/or formats.

There are many ways for alerting the subscriber that the context relevant aggregation and distribution service (e.g. 30, 150, 254) has information to report. FIGS. 8A-8F depict various embodiments of a user interface on a client device that can report the information to the subscriber. For example, FIG. 8A shows a mobile computing device 100 with a display showing two windows 102 and 104. The user is watching a video in window 102. A set of indicators (e.g., icons) are displayed in window 104. Each icon represents various types of content. For example, indicator S represents content related to shopping, indicator E represents content related to entertainment, indicator F represents content related to family and/or friends, indicator W represents content related to work, indicator N represents content related to news, and indicator O represents other types of content. When system 30 pushes content to device 100, the appropriate indicator (e.g. S, E, F, W, N or O) will be highlighted to indicated that new content has been pushed for the category. For example, FIG. 8A shows F being highlighted by bolding and underlining F. A user can tap on the “F” in order to bring up a window showing the newly pushed content.

FIG. 8B shows mobile computing device 110 with window 112 showing a video. While showing the video, a cloud based contextually relevant aggregation and distribution service system (e.g. 30, 150, 252) pushes new contextually relevant content to device 100 from another user account to which the user associated with device 110 subscribes, in this case, celebrity “Chef Bob”. Rather than show a set of indicators as depicted in FIG. 8A, the new content is automatically displayed in a window 114 overlaying the video. The content is an example of the place card from the example above (“New Wales Bistro, 0.5 mi., 135 Richmond St. (between 1st and 2nd). Chef Bob: ‘try the pretzel with welsh rarebit!’”)

FIG. 8C shows another embodiment, which includes mobile computing device 116 with a window 118 showing a video. When content is pushed to mobile computing device 116 by the service system (e.g. 30, 150, 252), an indicator 120 will be displayed in a portion of the display screen. The user can tap on the indicator 120 and a window (similar to window 114) will be displayed indicating the new content.

FIG. 8D shows another embodiment, which includes mobile computing device 122 illustrating tiles as examples of application icons which may be selected for launching the associated application. For example, there are tiles 126₁, 126₂ and 126₃ for applications for which contextually relevant content the user has not already viewed is not currently available. For applications useful for displaying or accessing content for which new contextually relevant content is available, a notification overlay with a descriptive statement 124 or particle in some embodiments is displayed. The user is notified by an overlay to a tile for the client module (e.g. 32, 250) that the shoes she was interested in are available nearby as indicated by “The brand X shoes are on sale at store Y, three blocks from your current location.” When the user clicks on the notification, the full street address and picture of the shoes appear in one example. Over an Internet Explorer® tile or icon is a notification 124₃ sent because the user subscribes to Chef Bob's account, and the notification informs the user that the “Chef Bob website has posted the prime rib recipe.” The service 30, 150, 252 had captured from the user's digital TV that the user had watched Chef's Bob TV program today on which the prime rib was made. Additionally, a notification indicating “Sally's Yosemite pictures posted” 124₂ is provided over a Flickr® tile for a contact, Sally, in the user's e-mail account who has been corresponded with a number of times above a trigger level recently.

FIG. 8E shows a mobile computing device 130 with a display showing two windows 132 and 134. The user is watching a video in window 132. A set of icons are displayed in window 134. Each icon represents people, places, or things (interests) with current activity. FIG. 8E shows the icons as squares; however, the icons can be images of the people, places, or things they represent. For example, an icon representing a friend can be a thumbnail photo of the friend. An icon representing a band can be the logo of the band.

FIG. 8F shows a mobile computing device 140 with a display 142, which can be a touch screen or other type of display. As depicted in FIG. 8F, display 142 shows a radar-like screen. Plotted on the radar are circles and text representing people, places or things for which a content aggregation and distribution service system 30, 150, 252 has delivered new information. The “U” represents the subscriber user. The closer an item is to the U, the more relevant the system 30 thinks the item is.

FIGS. 8A-8F provide six examples of alerting a subscriber of new content pushed from the service system 30, 150, 252 to a mobile computing device. These are just a small set of examples of possible user interfaces. No particular user interface is required for the technology described herein. Many different types of user interfaces can be used with the technology described herein. For example, other embodiments include sending a text message alert, or poping something up on a “ticker,” which is an unobtrusive UI that runs in the background showing a few of the interesting items found. Additionally, there can be multiple views of the information pushed to the mobile computing device: a timeline view, a map view, a list view, a collage view, etc.

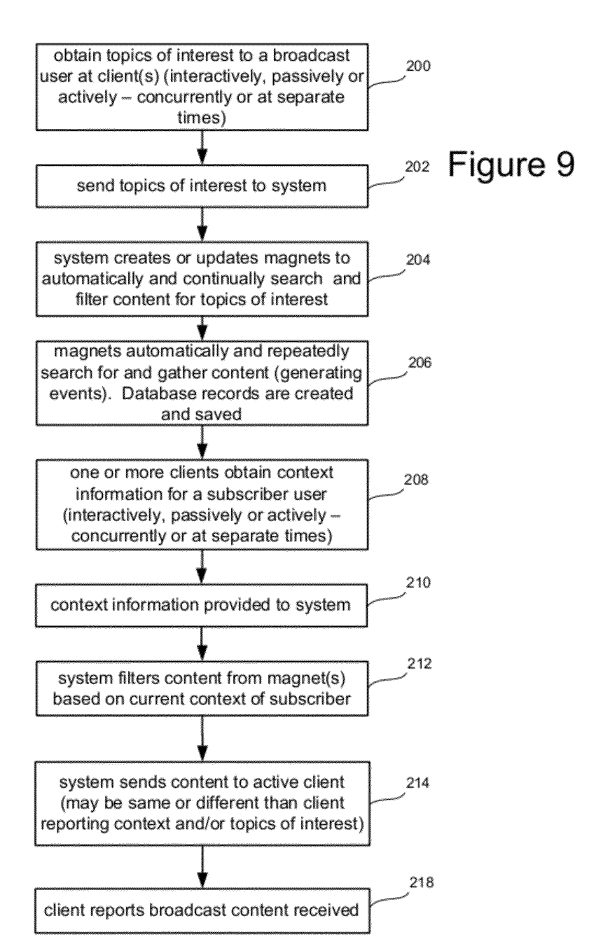

FIG. 9 is a flow chart describing one embodiment of a process for automatically and continuously finding and aggregating content related to a broadcast user which is contextually relevant to a subscriber. In step 200, a client module 32 obtains topics of interest to a broadcast user. The client module can obtain this information interactively, passively or actively, or a combination of the above, concurrently or at separate times. More information about obtaining topics of interest will be provided below. In response to interacting with or observing the user, the client module will generate topic data and communicate that topic data to a server 20 or other computer system that is part of a context relevant content aggregation and distribution service system (e.g. 30, 150, 252) in step 202.

In response to receiving the topics in step 202, the system 30, 150, 252 will create a new magnet or update an existing magnet (or other software component) in step 204 to automatically and continually search and filter content for the topics of interest without the broadcast user requesting that the content be gathered. If the topic of interest is something new, a new magnet is created by creating new criteria and starting a process to search the internet or other space for content related to that new criteria. If the topic received in step 202 is similar to the focus of an existing magnet, the existing magnet can be changed to modify its focus based on the new topic. In step 206, the magnets automatically and repeatedly search and gather content related to the seed for each magnet. For example, the magnets may identify events or news relevant to one or more of the topics. Although FIG. 9 shows the steps in a particular order, these steps can be performed in other orders. In one embodiment, step 206 is performed continuously; therefore, it is performed before, after and during many of the other steps of FIG. 9.

In step 208, one or more client modules will obtain context information for a subscriber associated with those client modules. The context information can be obtained interactively, passively or actively (concurrently or at separate times). The context information obtained in step 208 is provided to the content aggregation and distribution service system 30, 150, 252 in step 210. For example, the information is transmitted to a server that is part of the service system 30, 150, 252. In step 212, system 30, 150, 252 will filter content from one or more magnets based on the current context information provided in step 210. It is contemplated that the various magnets associated with a broadcast user will search for and identify a large amount of information. The current context information can be used to filter that information to a smaller subset. For example, if a magnet is searching for information about shoes a celebrity wore, and current context information indicates the location of the subscriber, the information about shoes can be filtered to only provide information about shoes sold in a store geographically close to the subscriber. In step 214, the information identified in step 212 is used to create an output message and that output message is sent to a client for the subscriber user.

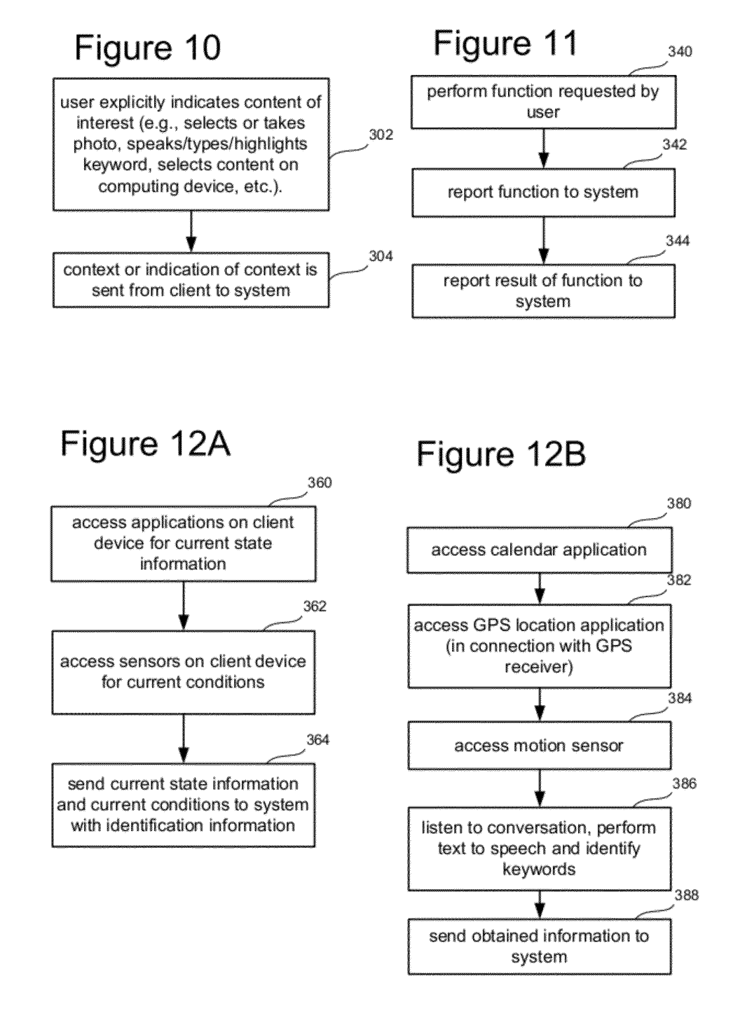

The content is sent to whatever client(s) is/are active for the user. In some instances, the client that sent the context information is the client that is currently active and, therefore, the result data will be sent to the same client. In other embodiments, the subscriber will be interacting with a first client device when the context information is sent to the contextually relevant content aggregation and distribution service system 30, 150, 252 and interacting with a second device when the result is reported back. Therefore, the result was reported to a different client device which may be a completely different type of device. For example, a subscriber may be playing a game executing on a console when context information is sent to the service system 30, 150, 252 and be using the cellular telephone when content still contextually relevant is sent back. Therefore, the information will be packaged for the user's cellular telephone rather than the game console. In step 218, the client device that received the data will report the new content in step 218, as described above or in any other suitable manner. More information about many of the steps of FIG. 9 will be provided below with respect to FIGS. 10-16.

FIG. 10 is a flowchart describing one embodiment of a process for a client module obtaining data interactively from a user and providing that data to a contextually relevant content aggregation and distribution service system. The process of FIG. 10 can be used to obtain topics of interest to a user and send them to the system 30, 150, 252 in step 200 or for obtaining context information in step 208 for communication to the service system. In step 302 of FIG. 10, the user explicitly indicates content of interest. For example a user may take a photo and request information about that photo, select a photo from existing photos on the user's computing device, speak a keyword, type a keyword, highlight a keyword in a document, select content on the computing device, etc. In any of these cases, the user is purposely choosing to identify content for which the user wants more information. This information may be a topic of interest. In some embodiments, the information can also provide context. In step 304, the context or indication of context is sent from a client module (e.g. 32, 250) to the service system (e.g. 30, 150, 252) (e.g. to one or more servers that implement the system).

FIG. 11 is a flowchart describing one embodiment of a process for a client module obtaining data (e.g., context data or topics of interest) actively. This process can be used as part of step 200 or step 208. In step 340 of FIG. 11, a client device will perform a function requested by the user. For example, the client device will load a web page, implement a telephone call, implement a text message, send an e-mail, play a game, chat, interact with a social networking site, or perform some other function. In step 342, a client module will report the function being performed to the system 30. In step 344, the client module will report the result of the function to the service system also. For example, if the user is playing a game, the result of the game will be reported. If the user is making a phone call, the result of the phone call (who the user called and whether the user ever made contact) can be reported to the service system and the service system uses this information both to create a digital history for the user and to refine stored knowledge about the user, and ultimately give more pertinent results.

FIG. 12A is a flowchart describing one embodiment of obtaining data (e.g., context data or topics of interest) passively. The process of FIG. 12A can be performed as part of steps 200 or 208 of FIG. 9. For example a cellular phone knows who the user is and where the user is located. A smart phone will know if the user is in a meeting and what the meeting is about. The smart phone could also be listening in, finding key words from speech patterns and providing those key words to a contextually relevant content aggregation and distribution service system to perform Internet searches based on those key words. So when a user and the user's friend are talking about a favorite sports team, statistics about that team can automatically be displayed on the cellular telephone. The client device can access applications on the client device for obtaining the data. Alternatively, the client module can access various sensors in the client device directly. In step 360, the client module will access applications on the client device for current state information. For example, if there is GPS or mapping software running on the client device, the client module can access the location software to obtain the current location of the mobile computing device. Similarly, an e-mail application can be accessed to identify currently received e-mails. In step 362, the client module will access sensors on the client device for current conditions. For example, the client module may access an orientation sensor, microphone, light sensor, temperature sensor, etc. on the client device to obtain various conditions of the environment that the user is currently in. In step 364, the state information from step 360 and the current conditions from step 362 are transmitted to the service system with identification information for the client device. In many embodiments, when data is transmitted, it is usually first used to create a message and that message is then transmitted. Note that the process of FIG. 10 is performed interactively with the user. However, the processes of FIGS. 11 and 12A are performed automatically without a request by the user to have the data sent.

FIG. 12B provides one example of an implementation of the process of FIG. 12A. In step 380, a client module will access a calendar application in a smart phone. For example, the client module will determine from the calendar application that the user is at a meeting with person A and person B. However, in this example, the meeting information in the calendar application does not identify the location. In step 382, the client module will access a GPS location application to determine the location of the user. Note that steps 380 and 382 are examples of step 360 of FIG. 12A. Steps 384-388 are examples of step 362 of FIG. 12A. In step 384, the client module will access a motion sensor in the smart phone to determine whether the user is moving. In step 386, the client module will utilize a microphone in the smart phone to listen to a conversation at the user's location. The device will perform text to speech in order to create searchable text. From the searchable text, the device will attempt to identify key words. The key words identified in step 386, along with the indication of motion, the location of the client device and the indication of the meeting obtained from the calendar will all be packaged into a message that is created and transmitted to the service system. This information may be appropriate for those involved with the meeting, but a meeting participant may set subscription settings in her account not to forward information such as keywords from conversations or a report on this meeting to her subscribers.

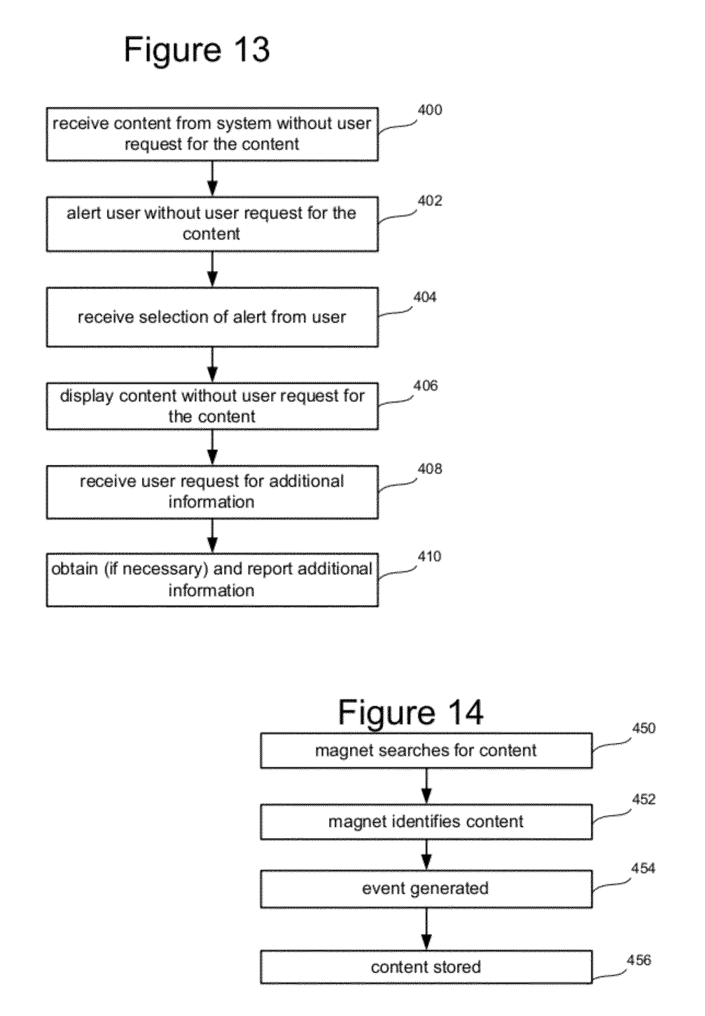

FIG. 13 is a flowchart describing one embodiment of the operation of a client module (e.g., client module 32) when it receives result information from a contextually relevant content aggregation and distribution service system 30, 150, 252. That is, the processes of FIGS. 10, 11 and 12A are used to send topics of interest and context information up to the service system from a client module. Based on that information received the service system will identify information of interest to the user and push that information back to the client. The process of FIG. 13 describes the actions performed by the client module when the client module receives that information pushed back to it by the service system.

In step 400 of FIG. 13, the client module will receive content from the service system without the user requesting that content. In step 402, the client module will alert the user about the new content. Again step 402 is performed without the user requesting the content. Examples of providing alert are discussed above with respect to FIGS. 8A-8F. In step 404, the client may (optionally) receive a selection of the alert from the user. If so, the content associated with the alert, which was received in step 400, is displayed in step 406. For example, step 402 may include displaying alert 120 of FIG. 8C and step 406 may include displaying window 114 or window 124₁ of FIGS. 8B or 8D. In step 408, the system may receive a request from the user for additional information. For example, in one embodiment, the content is displayed with a link for the user to request more information. If the user selects that link, then in step 410 the system will obtain or report the additional information. For example, if the user wanted more information about window 124₁ of FIG. 8D, in response to the user selecting the window a client module may inform the service system that more information is requested. In response to the request for more information, the service system may provide explicit details for the user to navigate to the store having the sale; for example, providing directions on taking public transportation, providing driving directions, etc. Alternatively, step 408 may include the user selecting one of the circles depicted in the user interface of FIG. 8F.

As described above, magnets are software processes that search for content relative to a seed. When content is found, the magnets will create a database entry and generate an event associated with that database entry. The database entry is stored and the event will trigger the filtering described above. FIG. 14 is a flowchart describing one embodiment of the process performed by the magnets to generate these events. In step 450 of FIG. 14, one or more magnets will search for content based on a seed topic, such as the topics of interest to the user, as described above. In step 452, the magnet will identify content. An event is generated in step 454, the content identified will be used to create a database entry and that database entry will be stored in step 456. As describe above, that data will then be used as part of a filtering process to potentially identify data to be pushed to the user.

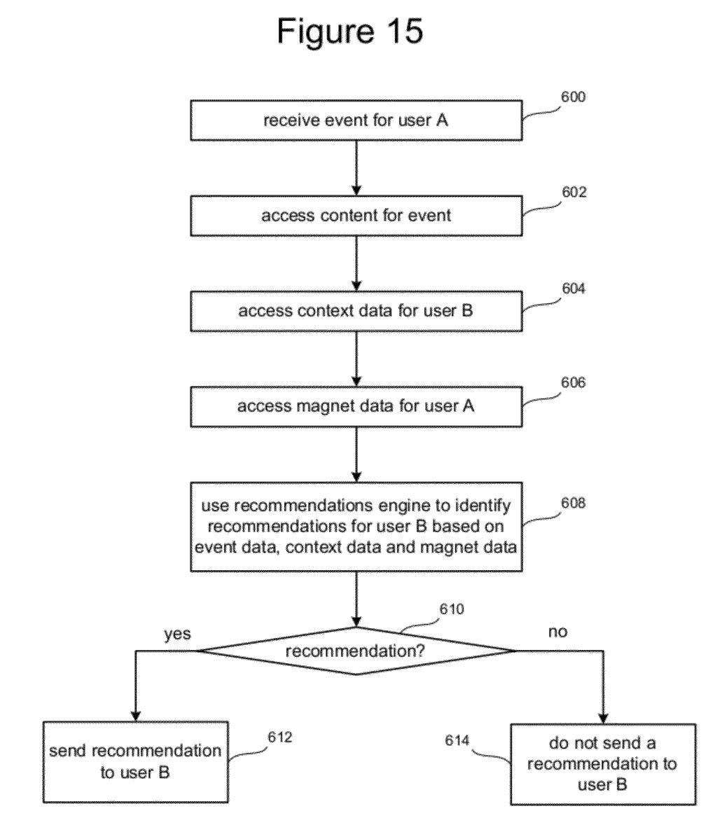

FIG. 15 is a flowchart describing one embodiment of a process performed by the system in the embodiment of FIG. 7A in response to the generation of an event. In one embodiment, the process of FIG. 15 can be performed by the intelligent processing module 174 of FIG. 7A,the controller 46 in FIG. 2 or the radar service 252 of FIG. 7B. In step 600, an event will be received for a broadcast user (for example purposes, the user will be referred to as user A). In step 602, content for the event is accessed. As described above, when an event is generated, a database record is generated and stored in a data store (e.g. 172). That database record is accessed in step 602. In step 604, context data for a subscriber user B is accessed from context data (e.g. 178, 282). In step 606, magnet data is accessed for user A. Any of the magnets that gathered data on behalf of user A will have that data stored in the data store. All or a subset of the data is accessed in step 606. In step 608, a recommendations engine (e.g. 48, 254, 260) will be used to identify recommendations for user B based on the event data for User A, context data for User B and the magnet data for User A accessed above. If a recommendation is generated (step 610), then the recommendation is sent to user B by pushing the content to the client device in step 612. If no recommendation is identified (step 610), then no content is pushed to user B's client device (step 614). Examples of a recommendation can include informing the user of a sale at a store of an organization represented by User A, a show at a theater for the band represented by User A, or a concert for the User A band, etc.

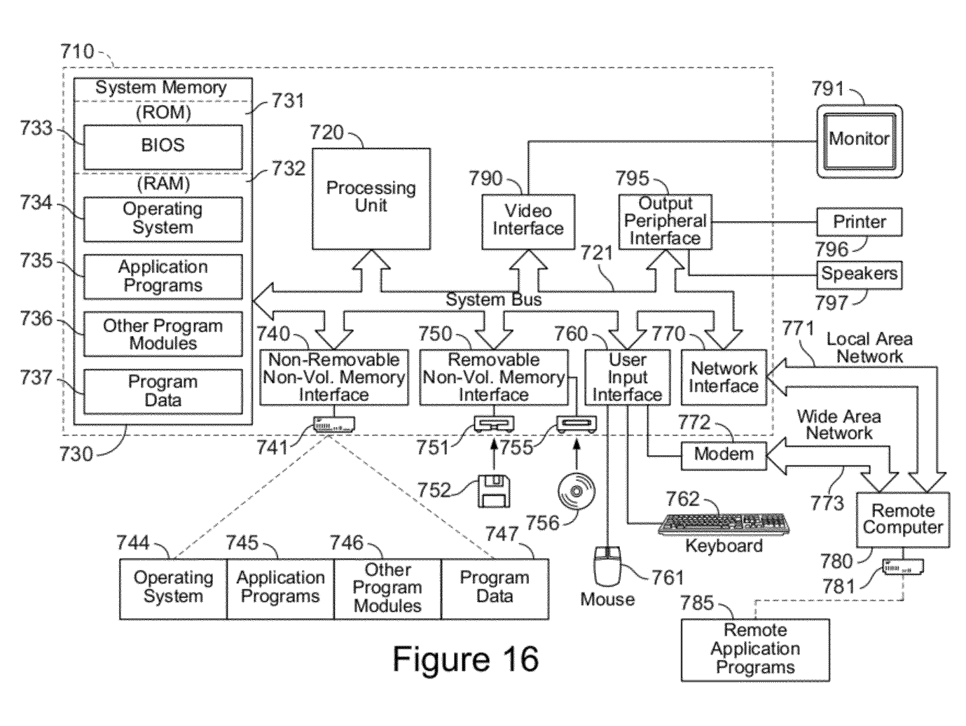

FIG. 16 depicts an exemplary computing system 710 for implementing any of the devices of FIG. 1. Computing system 710 of FIG. 16 can be used to perform the functions and processes described in the figures. Components of computer 710 may include, but are not limited to, a processing unit 720 (one or more processors that can perform the processes described herein), a system memory 730 (that can stored code to program the one or more processors to perform the processes described herein), and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and PCI Express.

Computing system 710 typically includes a variety of computer readable media. Computer readable media can be any available media that can be accessed by computing system 710 and includes both volatile and nonvolatile media, removable and non-removable media, including RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computing system 710.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 16 illustrates operating system 734, application programs 735, other program modules 736, and program data 737.

The computer 710 may also include other removable/non-removable, volatile/nonvolatile computer storage media. By way of example only, FIG. 16 illustrates a hard disk drive 740 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through an non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. 16, provide storage of computer readable instructions, data structures, program modules and other data for the computer 710. In FIG. 16, for example, hard disk drive 741 is illustrated as storing operating system 344, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. A user may enter commands and information into the computer through input devices such as a keyboard 762 and pointing device 761, commonly referred to as a mouse, trackball or touch pad. Other input devices (not shown) may include a microphone, joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through a output peripheral interface 790.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computing device 710, although only a memory storage device 781 has been illustrated in FIG. 16. The logical connections depicted in FIG. 16 include a local area network (LAN) 771 and a wide area network (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760, or other appropriate mechanism. In a networked environment, program modules depicted relative to the computer 710, or portions thereof, may be stored in the remote memory storage device. By way of example, and not limitation, FIG. 16 illustrates remote application programs 785 as residing on memory device 781. It will be appreciated that the network connections shown are exemplary and other means of establishing a communications link between the computers may be used.

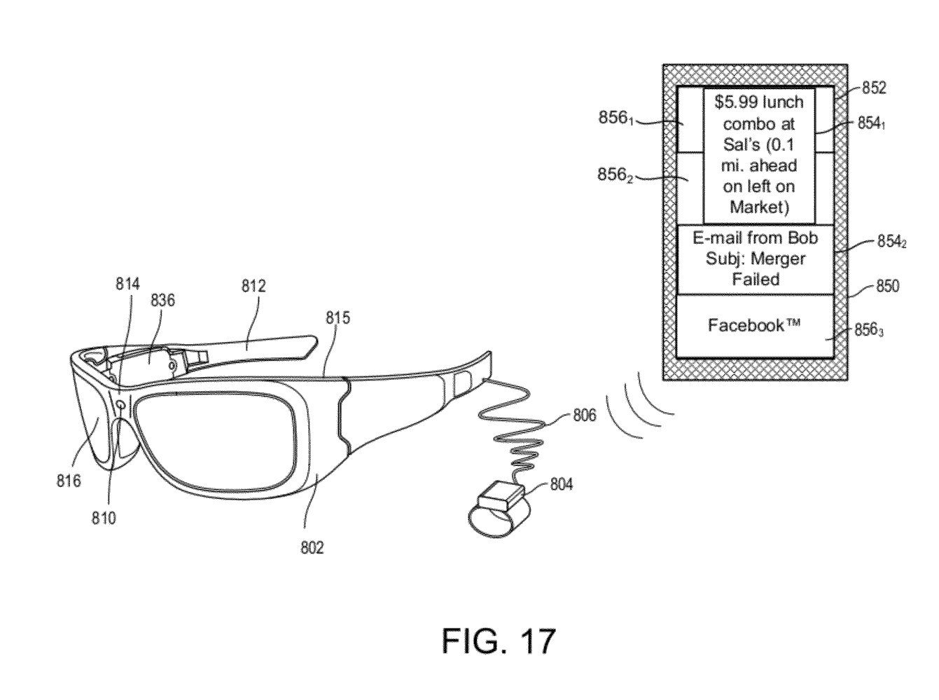

FIG. 17 is a top view of a portion of one embodiment of a head mounted display unit networked with a mobile device for use by the technology for providing content related to a broadcast user to a subscriber user based on the context of the subscriber. FIG. 17 illustrates a see-through display device as a near-eye, head mounted display device 802 in communication with processing unit 804 via wire 806. In other embodiments, head mounted display device 802 communicates with processing unit 804 via wireless communication. The head mounted display device 802 is shown in the shape of glasses in which frame 815 provides a support for holding elements of the system in place as well as a conduit for electrical connections. The frame includes a temple 812 supporting control circuits 836 which provide various electronics that support the other components of head mounted display device 802. Built into nose bridge 814 is a microphone 810 for recording sounds and transmitting that audio data to processing unit 804. The glasses include a pair of see-through lenses 816.

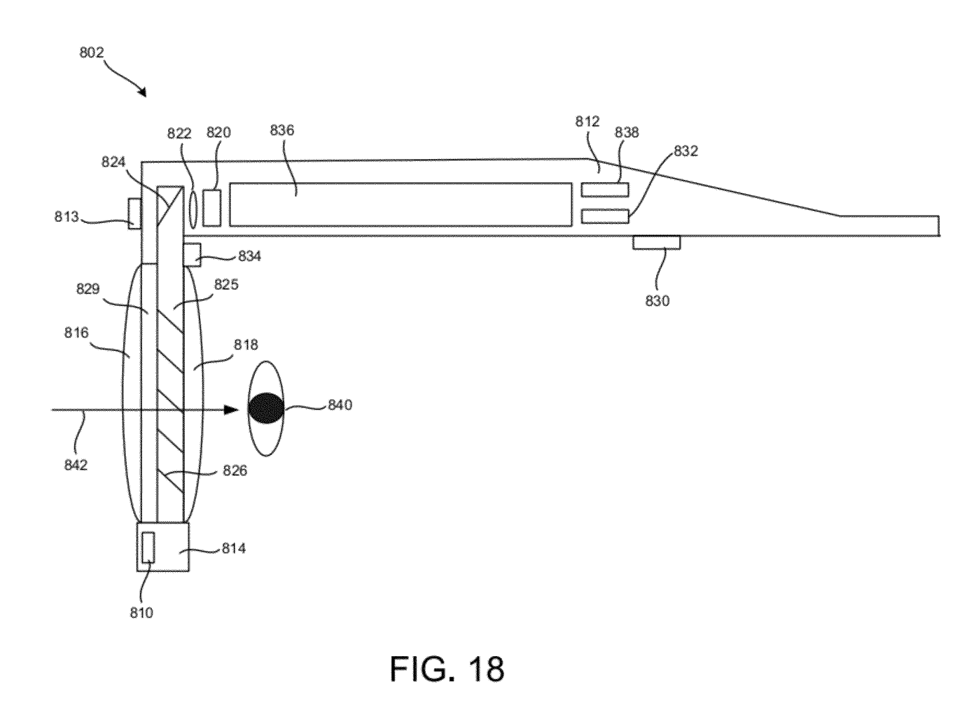

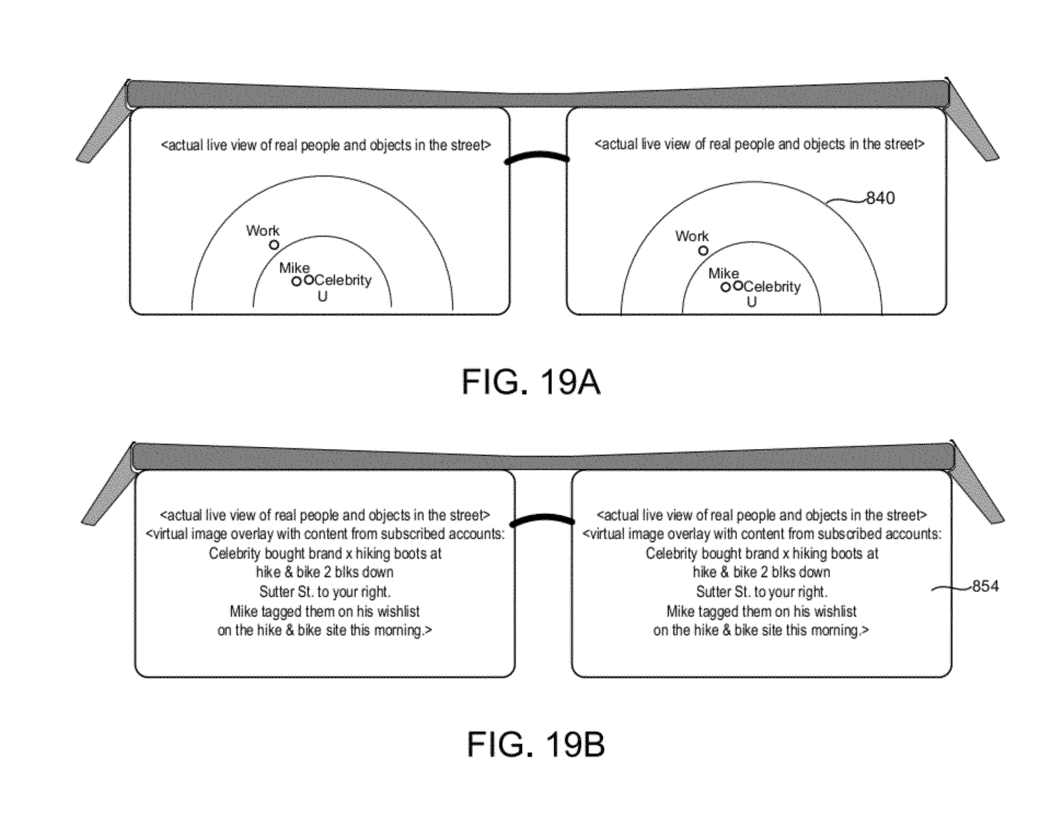

Head mounted display device 802, which in one embodiment is in the shape of glasses, is worn on the head of a user so that the user can see through a display and thereby have an actual direct view of the space in front of the user. The use of the term “actual and direct view” refers to the ability to see the real world objects directly with the human eye, rather than seeing created image representations of the objects. For example, looking through glass at a room allows a user to have an actual direct view of the room, while viewing a video of a room on a television is not an actual direct view of the room. More details of the head mounted display device 802 are provided below. Although the device shown in FIGS. 18 and 19 is in the form of glasses, the head mounted display device 802 may take other forms, such as a helmet with goggles.

In one embodiment, processing unit 804 is worn on the user's wrist and includes a portion of the computing power used to operate head mounted display device 802. Processing unit 804 communicates wirelessly (e.g., WiFi, Bluetooth, infra-red, or other wireless communication means) to one or more computer devices such as in this example a mobile device of a smartphone 850. A client module 32 such as a radar service client module 250 is executing on the smartphone 850 to which the display device 802 is wirelessly coupled. The client module 32 provides connection information and operating status information on the display device 802 to the service 30. The smartphone display 852 displays application tiles including one for a Facebook application instance 856₃. The other tiles 856₁ and 856₂ are overlaid with a particle or message 854₁ from a contextually relevant content aggregation and distribution service system. In this example, the user is walking during lunchtime in downtown San Francisco on Market Street, and receives the contextually relevant content message of “$5.99 lunch combo at Sal's (0.1 mi. ahead on left on Market). Additionally, the user's smartphone is not logged in to her work network, but the radar service 252 sends her a message which is displayed as an overlay 854₂ “E-mail from Bob Subj: Merger Failed” as content indicating she has received an e-mail in her work e-mail account. The user does not need to log in and check her work e-mail during her lunchtime to track her e-mails; a service application (e.g. 252) notifies her instead. The user has designated in her device limitations that content received from her husband's user account and a celebrity chef, Chef Bob, are to be displayed during work hours to her mixed-reality display system 802.

FIG. 18 is a block diagram of one embodiment of the components of a head mounted display unit. FIG. 18 depicts a top view of a portion of head mounted display device 802. Only the right side of head mounted display device 802 is depicted. At the front of head mounted display device 802 is front facing video camera 813 that can capture video and still images of what is in front of the user's eyes. Those images are transmitted to processing unit 804, as described below.

A portion of the frame of head mounted display device 802 will surround a display (that includes one or more lenses). In order to show the components of head mounted display device 802, a portion of the frame surrounding the display is not depicted. The display includes a light guide optical element 825, opacity filter 829, see-through lens 816 and see-through lens 818. In one embodiment, the opacity filter 829 is behind and aligned with see-through lens 816, lightguide optical element 825 is behind and aligned with opacity filter 829, and see-through lens 818 is behind and aligned with lightguide optical element 825. See-through lenses 816 and 818 are standard lenses used in eye glasses and can be made to any prescription (including no prescription). In one embodiment, see-through lenses 816 and 818 can be replaced by a variable prescription lens. In some embodiments, head mounted display device 802 will include only one see-through lens or no see-through lenses. In another alternative, a prescription lens can go inside light guide optical element 825. Opacity filter 829 filters out natural light (either on a per pixel basis or uniformly) to enhance the contrast of the virtual imagery. Light guide optical element 825 channels artificial light to the eye.

Mounted to or inside temple 812 is an image source, which (in one embodiment) includes micro display assembly 820 for projecting a virtual image and lens 822 for directing images from micro display 820 into light guide optical element 825. In one embodiment, lens 822 is a collimating lens.

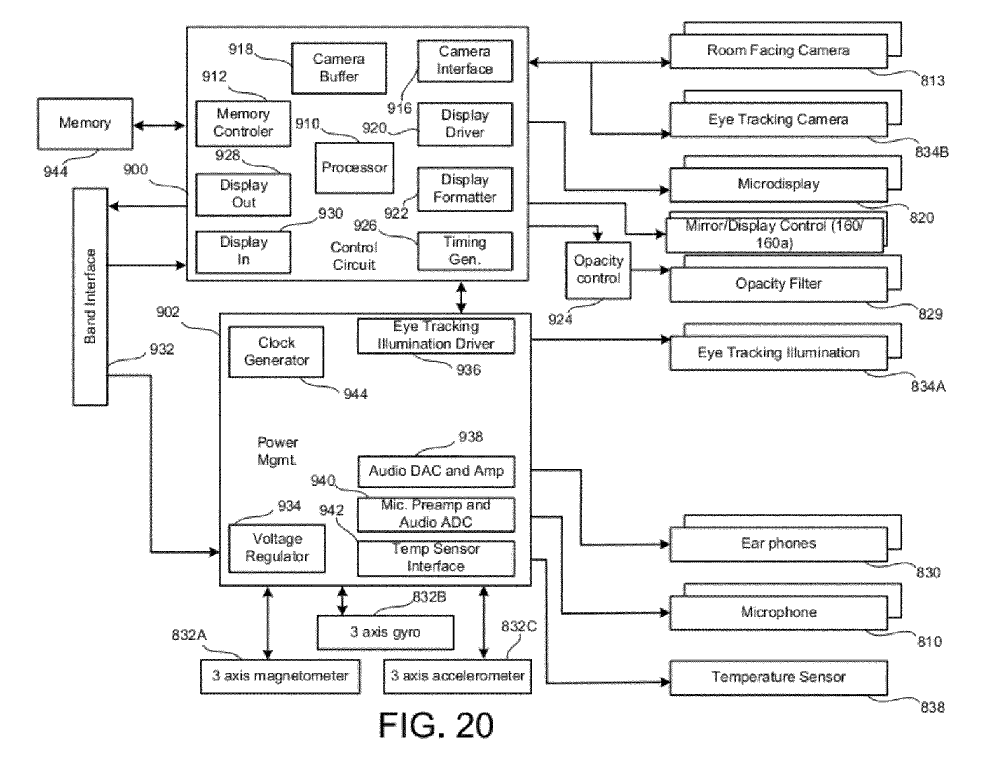

More details of control circuits 836 are provided below with respect to FIG. 20. Inside, or mounted to temple 812, are ear phones 830, inertial and/or magnetic sensors 832 and temperature sensor 838. In one embodiment inertial and magnetic sensors 832 include a three axis magnetometer 832A, three axis gyro 832B and three axis accelerometer 832C. The inertial and/or magnetic sensors are for sensing position, orientation, and sudden accelerations of head mounted display device 802.

Micro display 820 projects an image through lens 822. There are different image generation technologies that can be used to implement micro display 820. For example, micro display 820 can be implemented in using a transmissive projection technology where the light source is modulated by optically active material, backlit with white light. These technologies are usually implemented using LCD type displays with powerful backlights and high optical energy densities. Micro display 820 can also be implemented using a reflective technology for which external light is reflected and modulated by an optically active material. The illumination is forward lit by either a white source or RGB source, depending on the technology. Digital light processing (DLP), liquid crystal on silicon (LCOS) and Mirasol® display technology from Qualcomm, inc. are all examples of reflective technologies which are efficient as most energy is reflected away from the modulated structure and may be used in the system described herein. Additionally, micro display 820 can be implemented using an emissive technology where light is generated by the display. For example, a PicoP™ display engine from Microvision, Inc. emits a laser signal with a micro mirror steering either onto a tiny screen that acts as a transmissive element or beamed directly into the eye (e.g., laser).

Light guide optical element 825 transmits light from micro display 820 to the eye 840 of the user wearing head mounted display device 802. Light guide optical element 825 also allows light from in front of the head mounted display device 802 to be transmitted through light guide optical element 825 to eye 840, as depicted by arrow 842, thereby allowing the user to have an actual direct view of the space in front of head mounted display device 802 in addition to receiving a virtual image from micro display 820. Thus, the walls of light guide optical element 825 are see-through. Light guide optical element 825 includes a first reflecting surface 824 (e.g., a mirror or other surface). Light from micro display 820 passes through lens 822 and becomes incident on reflecting surface 824. The reflecting surface 824 reflects the incident light from the micro display 820 such that light is trapped inside a planar, substrate comprising light guide optical element 825 by internal reflection. After several reflections off the surfaces of the substrate, the trapped light waves reach an array of selectively reflecting surfaces 826. Note that only one of the five surfaces is labeled 826 to prevent over-crowding of the drawing. Reflecting surfaces 826 couple the light waves incident upon those reflecting surfaces out of the substrate into the eye 840 of the user. As different light rays will travel and bounce off the inside of the substrate at different angles, the different rays will hit the various reflecting surface 826 at different angles. Therefore, different light rays will be reflected out of the substrate by different ones of the reflecting surfaces. The selection of which light rays will be reflected out of the substrate by which surface 826 is engineered by selecting an appropriate angle of the surfaces 826. More details of a light guide optical element can be found in United States Patent Application Publication 2008/0285140, Ser. No. 12/214,366, published on Nov. 20, 2008, “Substrate-Guided Optical Devices” incorporated herein by reference in its entirety. In another embodiment, there can be one light guide optical element which reflects light into both eyes.

Opacity filter 829, which is aligned with light guide optical element 825, selectively blocks natural light, either uniformly or on a per-pixel basis, from passing through light guide optical element 825. In one embodiment, the opacity filter can be a see-through LCD panel, electro chromic film, PDLC (Polymer dispersed Liquid Crystal) or similar device which is capable of serving as an opacity filter.

Head mounted display device 802 also includes a system for tracking the position of the user's eyes as a user's eyes will be directed at a subset of the environment. Head mounted display device 802 includes eye tracking assembly 134 which includes an eye tracking illumination device 134A (see FIG. 20) and eye tracking camera 134B (see FIG. 20). In one embodiment, eye tracking illumination source 134A includes one or more infrared (IR) emitters, which emit IR light toward the eye. Eye tracking camera 134B includes one or more cameras that sense the reflected IR light. The position of the pupil can be identified by known imaging techniques which detects the reflection of the cornea. For example, see U.S. Pat. No. 7,401,920, entitled “Head Mounted Eye Tracking and Display System”, issued Jul. 22, 2008 to Kranz et al., incorporated herein by reference. Such a technique can locate a position of the center of the eye relative to the tracking camera. Generally, eye tracking involves obtaining an image of the eye and using computer vision techniques to determine the location of the pupil within the eye socket. In one embodiment, it is sufficient to track the location of one eye since the eye usually moves in unison. However, it is possible to track each eye separately.

FIG. 19A is an illustration of an overlay of a radar like notification virtual overlay 840 presented overlaying the subscriber's view of the subscriber's environment. As per FIG. 8F, content related to the user's husband Mike and the celebrity, her subscribed accounts, are much closer to the “U” representing the user than the Work content, e.g. the e-mail about the merger failure 854₂. The closest may be an indication of the contextual relevance of the subscribed accounts content, as the user is walking at lunchtime in downtown San Francisco as she does fairly regularly as determined by the service (e.g. 30, 150, 252) from tracking her context information such as GPS data from her smartphone and transactions to her electronic wallet she or the merchant has permitted the service system to see or a budget software application she uses.

Via a user input mechanism for the see-through display 802, for example an input device such as a button or trackball on the wristband which interfaces with the processing unit 804, the user is able to select the content for Mike and the Celebrity.

FIG. 19B is an illustration of a virtual overlay of contextually relevant content from exemplar broadcast user accounts to which the user subscribes presented overlaying the subscriber's view of the subscriber's environment. A contextually relevant virtual overlay 854 with content in the form of messages with information from the user accounts she has subscribed is displayed: “Celebrity bought brand x hiking boots at hike & bike 2 blks down Sutter St. to your right” and “Mike tagged them on his wishlist on the hike & bike site this morning.” Both messages would receive a high confidence relevancy score as the user is very near a hike & bike store.

In some embodiments, a broadcaster may allow subscribers to link in real-time to a video or images feed, with or without sound, of what the room or front facing camera 813 is capturing while the broadcaster is wearing them. For example, a musician is performing a concert at a stadium and is wearing a near-eye or head mounted display 802. Before the concert or during, the musician has updated his subscription settings in his broadcast account to allow subscribers identified as having a context of being physically in the stadium to be able to view on displays accessible by the service what he is seeing during the concert. The stadium computer system may be a subscriber and may be able to display on a large screen in the stadium. Subscribers may also view the feed on their mobile device displays or near-eye displays.

In other embodiments, a broadcaster may allow a video or images captured by the front facing camera 813 to be captured and stored for his broadcast account. When a subscriber is in the same context, e.g. walking on the same street in a city, or just in the same city, a notification of the available feed is received from the service by a client module and is displayed on a client device available to the subscriber. The subscriber can then view the feed on his or her mobile device or near-eye display. If the mobile device or near-eye display can access GPS or other location finding technology which can provide position information to within a street block or two, the video or images can track its output to the user's progress along the route of the video or images. Besides celebrities, this allows many opportunities to communicate with users who permit their views to be broadcast to another user to explain their surroundings in their own languages in different localities. Some examples of services which may take advantage of such capability are tourist services, emergency services, and directions services.

FIG. 20 is a block diagram of one embodiment of the components of a head mounted display unit. Some of the components of FIG. 20 (e.g., front facing camera 813, eye tracking camera 834B, micro display 820, opacity filter 829, eye tracking illumination 834A, and earphones 830) are shown in shadow to indicate that there may be two of each of those devices, one for the left side and one for the right side of head mounted display device 802. FIG. 20 shows the control circuit 900 in communication with the power management circuit 902. Control circuit 900 includes processor 910, memory controller 912 in communication with memory 914 (e.g., D-RAM), camera interface 916, camera buffer 918, display driver 920, display formatter 922, timing generator 926, display out interface 928, and display in interface 930. In one embodiment, all of components of control circuit 900 are in communication with each other via dedicated lines or one or more buses. In another embodiment, each of the components of control circuit 900 is in communication with processor 910. Camera interface 916 provides an interface to the two front facing cameras 813 and stores images received from the front facing cameras in camera buffer 918. Display driver 920 will drive micro display 820. Display formatter 922 provides information, about the virtual image being displayed on micro display 820, to opacity control circuit 924, which controls opacity filter 829. Timing generator 926 is used to provide timing data for the system. Display out interface 928 is a buffer for providing images from front facing cameras 813 to the processing unit 804. Display in 930 is a buffer for receiving images such as a virtual image to be displayed on micro display 820. Display out 928 and display in 930 communicate with band interface 932 which is an interface to processing unit 804.

Power management circuit 902 includes voltage regulator 934, eye tracking illumination driver 936, audio DAC and amplifier 938, microphone preamplifier audio ADC 940, temperature sensor interface 942 and clock generator 944. Voltage regulator 934 receives power from processing unit 804 via band interface 932 and provides that power to the other components of head mounted display device 802. Eye tracking illumination driver 936 provides the IR light source for eye tracking illumination 834A, as described above. Audio DAC and amplifier 238 receive the audio information from earphones 830. Microphone preamplifier and audio ADC 940 provide an interface for microphone 810. Temperature sensor interface 942 is an interface for temperature sensor 838. Power management unit 902 also provides power and receives data back from three axis magnetometer 832A, three axis gyro 832B and three axis accelerometer 832C.

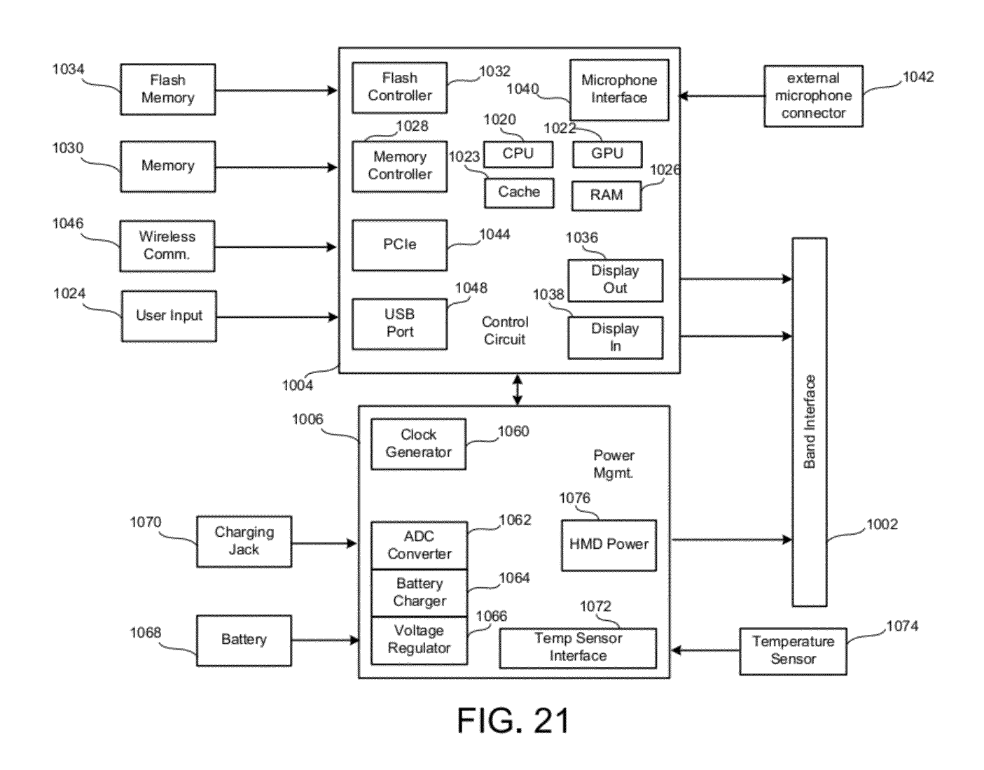

FIG. 21 is a block diagram of one embodiment of the components of a processing unit associated with a head mounted display unit. FIG. 21 shows controls circuit 1004 in communication with power management circuit 1006. Control circuit 1004 includes a central processing unit (CPU) 1020 communicatively coupled to user input device 1024 to receive user input, graphics processing unit (GPU) 1022, cache 1023, RAM 1026, memory control 1028 in communication with memory 1030 (e.g., D-RAM), flash memory controller 1032 in communication with flash memory 1034 (or other type of non-volatile storage), display out buffer 1036 in communication with head mounted display device 802 via band interface 1002 and band interface 932, display in buffer 1038 in communication with head mounted display device 802 via band interface 1002 and band interface 932, microphone interface 1040 in communication with an external microphone connector 1042 for connecting to a microphone, PCI express interface for connecting to a wireless communication device 1046, and USB port(s) 1048. In one embodiment, wireless communication device 1046 can include a Wi-Fi enabled communication device, BlueTooth communication device, infrared communication device, etc. The USB port can be used to dock the processing unit 804 to a user computer device like smartphone 850 in order to load data or software onto processing unit 804, as well as charge processing unit 804. In one embodiment, CPU 1020 and GPU 1022 are the main workhorses for determining where, when and how to insert virtual images into the view of the user.

Power management circuit 1006 includes clock generator 1060, analog to digital converter 1062, battery charger 1064, voltage regulator 1066, head mounted display power source 1076, and temperature sensor interface 1072 in communication with temperature sensor 1074 (located on the wrist band of processing unit 804). Analog to digital converter 1062 is connected to a charging jack 1070 for receiving an AC supply and creating a DC supply for the system. Voltage regulator 1066 is in communication with battery 1068 for supplying power to the system. Battery charger 1064 is used to charge battery 1068 (via voltage regulator 1066) upon receiving power from charging jack 1070. HMD power source 1076 provides power to the head mounted display device 802.

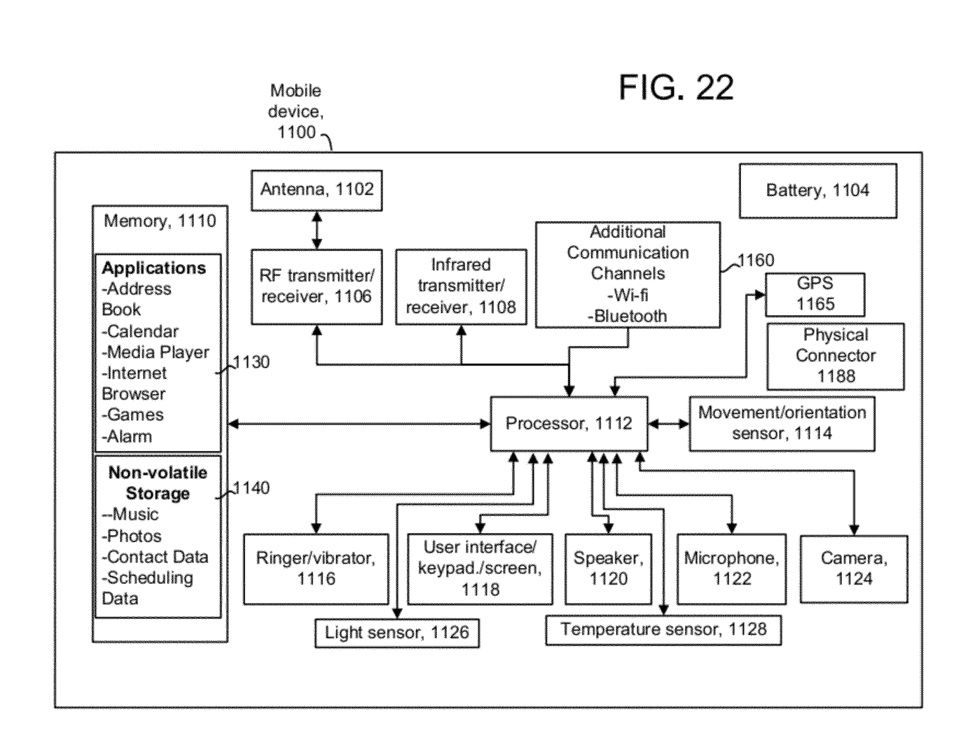

FIG. 22 is a block diagram of an example mobile device which may be used to implement one or more embodiments of a client device. Exemplary electronic circuitry of a typical mobile phone is depicted. The phone 1100 includes one or more microprocessors 1112, and memory 1110 (e.g., non-volatile memory such as ROM and volatile memory such as RAM) which stores processor-readable code which is executed by one or more processors of the control processor 1112 to implement the functionality described herein.

Mobile device 1100 may include, for example, processors 1112, memory 1110 including applications and non-volatile storage. The processor 1112 can implement communications, as well as any number of applications, including the interaction applications discussed herein. Memory 1110 can be any variety of memory storage media types, including non-volatile and volatile memory. A device operating system handles the different operations of the mobile device 1100 and may contain user interfaces for operations, such as placing and receiving phone calls, text messaging, checking voicemail, and the like. The applications 1130 can be any assortment of programs, such as a camera application for photos and/or videos, an address book, a calendar application, a media player, an internet browser, games, an alarm application, other third party applications, the interaction application discussed herein, and the like. The non-volatile storage component 1140 in memory 1110 contains data such as web caches, music, photos, contact data, scheduling data, and other files.

The processor 1112 also communicates with RF transmit/receive circuitry 1106 which in turn is coupled to an antenna 1102, with an infrared transmitted/receiver 1108, with any additional communication channels 1160 like Wi-Fi or Bluetooth, and with a movement/orientation sensor 1114 such as an accelerometer. Accelerometers have been incorporated into mobile devices to enable such applications as intelligent user interfaces that let users input commands through gestures, indoor GPS functionality which calculates the movement and direction of the device after contact is broken with a GPS satellite, and to detect the orientation of the device and automatically change the display from portrait to landscape when the phone is rotated. An accelerometer can be provided, e.g., by a micro-electromechanical system (MEMS) which is a tiny mechanical device (of micrometer dimensions) built onto a semiconductor chip. Acceleration direction, as well as orientation, vibration and shock can be sensed. The processor 1112 further communicates with a ringer/vibrator 1116, a user interface keypad/screen 1118, a speaker 1120, a microphone 1122, a camera 1124, a light sensor 1126 and a temperature sensor 1128.

The processor 1112 controls transmission and reception of wireless signals. During a transmission mode, the processor 1112 provides a voice signal from microphone 1122, or other data signal, to the transmit/receive circuitry 1106. The transmit/receive circuitry 1106 transmits the signal to a remote station (e.g., a fixed station, operator, other cellular phones, etc.) for communication through the antenna 1102. The ringer/vibrator 1116 is used to signal an incoming call, text message, calendar reminder, alarm clock reminder, or other notification to the user. During a receiving mode, the transmit/receive circuitry 1106 receives a voice or other data signal from a remote station through the antenna 1102. A received voice signal is provided to the speaker 1120 while other received data signals are also processed appropriately.

Additionally, a physical connector 1188 can be used to connect the mobile device 800 to an external power source, such as an AC adapter or powered docking station. The physical connector 1188 can also be used as a data connection to a computing device. The data connection allows for operations such as synchronizing mobile device data with the computing data on another device.

A GPS receiver 1165 utilizing satellite-based radio navigation to relay the position of the user applications is enabled for such service.

The technology may be embodied in other specific forms without departing from the spirit or essential characteristics thereof. Likewise, the particular naming and division of modules, routines, features, attributes, methodologies and other aspects are not mandatory, and the mechanisms that implement the technology or its features may have different names, divisions and/or formats. Furthermore, as will be apparent to one of ordinary skill in the relevant art, the modules, routines, features, attributes, methodologies and other aspects of the embodiments disclosed can be implemented as software, hardware, firmware or any combination of the three. Of course, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of programming

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

What is claimed is:

1. A method for providing content related to a user to another user based on a context of the other user, comprising:
subscribing a user account of a second user to a user account of a first user;
automatically gathering content about one or more topics of interest for the first user from online resources;
receiving context information from one or more client modules executing on one or more computer devices associated with the second user;
filtering content gathered for the first user for contextual relevance to the second user; and
reporting the filtered content to one or more client modules executing on the one or more devices associated with the second user.

2. The method of claim 1, wherein:
the filtering content gathered for the first user for contextual relevance to the second user further comprises filtering content gathered for the first user independently of the current context of the first user.

3. The method of claim 1, wherein:
the context information for the second user includes a physical location.

4. The method of claim 1, wherein:
the context information for the second user includes a mode associated with one or more computer devices associated with the second user upon which a client module is executing.

5. The method of claim 4, wherein the mode is a work mode.

6. The method of claim 1 further comprising:
obtaining one or more subscription settings from the first user related to content distribution to subscribers;
obtaining one or more subscription settings from the subscriber second user for receiving content gathered for the first user account; and wherein
reporting the filtered content to one or more client modules executing on the one or more devices associated with the second user is performed based on the one or more subscription settings for the first user account and the one or more subscription settings for the subscriber second unit account.

7. The method of claim 6 wherein:
obtaining one or more subscription settings from the first user related to content distribution to subscribers further comprises:
receiving a selection of one or more topics of interest to the first user available for content sharing with subscribers independent of an online source for the content, and
storing the selection of one or more topics for sharing in the subscription settings for the first user account; and
obtaining one or more subscription settings from the subscriber second user for receiving content gathered for the first user account further comprises:
receiving a selection of one or more topics of interest to the first user for which the subscriber wants to receive content from the first user independent of the online source for the content; and
storing the selection of one or more topics for which to receive content in the subscription settings for the second user account.

8. The method of claim 6, wherein:
obtaining one or more subscription settings from the first user related to content distribution to subscribers further comprises:
receiving a selection of one or more context limitations on content to be shared with subscribers, and
storing the selection of one or more context limitations for sharing in the subscription settings for the first user account; and
obtaining one or more subscription settings from the subscriber second user for receiving content gathered for the first user account further comprises:
receiving a selection of one or more context limitations for the second user for content being received from the first user account, and
storing the selection of one or more context limitations for content being received from the first user account in the subscription settings for the second user account.

9. The method of claim 6, wherein:
obtaining one or more subscription settings from the subscriber second user for receiving content gathered for the first user account further comprises:
receiving a selection of one or more device limitations for the second user for content being received from the first user account, and
storing the selection of one or more device limitations for content being received from the first user account in the subscription settings for the second user account.

10. The method of claim 6, wherein:
obtaining one or more subscription settings from the first user related to content distribution to subscribers further comprises:
receiving from the first user a selection of one or more authorization criteria for content to be shared with subscribers; and
storing the selection of one or more authorization criteria in the subscription settings for the first user account.

11. A system for providing content related to a user to another user based on a context of the other user, comprising:
a first set of one or more computers comprising a radar service that is in communication with one or more client modules executing on computer devices associated with a first user and a second user, the first set of one or more computers receives indications of topics of interest and context information from a first client module associated with the first user and from a second client module associated with the second user;
a second set of one or more computers comprising an executing intelligence system in communication with the first set of one or more computers comprising the radar service, the second set of one or more computer stores one or more indexes of resources to search for information available for aggregation;
the first set of one or more computers uses the indications of topics of interest from the first client module and the one or more indexes to automatically and continuously gather content about the topics of interest to the first user; and
the first set of one or more computers filters the gathered content based on the topics of interest of the first user and the context information provided by the second client module for the second user and pushes the filtered content to one or more client modules executing on computer devices associated with the second user.

12. The system of claim 11, wherein:
the first set of one or more computers include a relevancy engine which participates in filtering the gathered content by assigning a relevancy score to the gathered content based on how pertinent the gathered content is to the context of the second user.

13. The system of claim 11, wherein:
the first set of one or more computers include magnets, which are persistent and personalized software modules that automatically and continuously collect information about a topic of interest.

14. The system of claim 13, wherein:
the first set of one or more computers include one or more recommendation engines, the magnets use the recommendation engines to identify content via a network; and
the first set of one or more computers include a relevancy engine that participates in filtering the gathered content by assigning a relevancy score to the gathered content based on how pertinent the gathered content is to the context of the second user.

15. One or more processor readable storage devices having processor readable code embodied on the one or more processor readable storage devices, the processor readable code for programming one or more processors to perform a method for providing content related to a user to another user based on a context of the other user, the method comprising:
subscribing a user account of a second user to a user account of a first user;
automatically gathering content about one or more topics of interest for the first user from online resources;
determining a context based on context information received from one or more client modules executing on one or more computer devices associated with the second user;
filtering the content gathered for the first user based on relevance to the context of the second user; and
reporting the filtered content to one or more client modules executing on one or more user computer devices in accordance with device limitations indicated by the second user for receiving the filtered content.

16. The one or more processor readable storage devices of claim 15, wherein reporting the filtered content to one or more client modules executing on one or more user computer devices in accordance with device limitations indicated by the second user for receiving the filtered content further comprises:
determine if a user computer device selected for receiving the filtered content is available for receiving the content; and
responsive to the selected device being available, sending the filtered content to the selected device for outputting to the second user.

17. The one or more processor readable storage devices of claim 16, wherein determining if a user computer device selected for receiving the filtered content for output is available for receiving the content further comprises:
determining whether context information for the user computer device indicates the user computer device is unavailable based on a network connection mode type for the user computer device.

18. The one or more processor readable storage devices of claim 16, wherein the selected user output device is communicated with indirectly via one or more different user computer devices and determining if the user output device selected for receiving the filtered content for output is available for receiving the content further comprises:
determining whether the one or more different user computer devices is in communication with the selected user output device and is in a vicinity of the second user; and
responsive to the selected user output device being in communication with one of the different user computer devices and being in a vicinity of the second user, sending the filtered content to the one of the different user computer devices with an indication to display the filtered content on the selected user output device.

19. The one or more processor readable storage devices of claim 18 wherein the selected user output device is a human wearable display device.

20. The one or more processor readable storage devices of claim 19 wherein the human wearable display device is a mixed reality see-through device.
